(19) United States
(12) Patent Application Publication
(10) Pub. No.: US 2001/0014839 A1
(43) Pub. Date: Aug. 16, 2001

(54) REMOTE COMMUNICATION AND INFORMATION MANAGEMENT SYSTEM

(76) Inventors: CHARLES E. BELANGER, BILLERICA, MA (US); JASON WOODLEE, BOSTON, MA (US)

Correspondence Address: FOLEY, HOAG & ELIOT, LLP, PATENT GROUP, ONE POST OFFICE SQUARE, BOSTON, MA, 02109, US

(21) Appl. No.: 08/970,894

(22) Filed: Nov. 14, 1997

Related U.S. Application Data
(60) Provisional application No. 60/030,994, filed on Nov. 15, 1996.
(60) Provisional application No. 60/030,996, filed on Nov. 15, 1996.
(60) Provisional application No. 60/038,411, filed on Feb. 18, 1997.
(60) Provisional application No. 60/055,782, filed on Aug. 15, 1997.
(60) Provisional application No. 60/057,256, filed on Aug. 29, 1997.
(60) Provisional application No. 60/060,612, filed on Oct. 1, 1997.

(51) Int. Cl. H04M 1/64

(52) U.S. Cl. 700/245; 707/10; 707/102

(57) ABSTRACT

The systems and methods described herein provide different types of Web authoring, Web site management, and communication software technology, including but not limited to full multimedia authoring, online libraries, sounds, forms, e-mail, facsimile, voice-mail, pager, telephone, financial management, true document printing (as opposed to screen printing), text-to-voice and voice-to-text conversion, file management, spreadsheets, all accessed and run via the Internet. The system resides entirely on an Internet Web Server site and interacts with users via conventional programming languages written for a universal protocol. As a result, there is no need for client-side messaging software. All software is provided on the server side. The only software the user needs is any form of Web browser and an electronic communications connection. Because the system is platform and operating system independent, a user may author, create, maintain, send and receive messages from any platform, using any conventional operating system. A user may customize their desktop configuration and may run a variety of different applications. Moreover, a user may switch between applications, and transfer text, graphics, or sound files between applications.

### CROSS-REFERENCE TO RELATED APPLICATIONS

This application is related to U.S. provisional patent application serial No. 60/030,994, entitled, “Remote Communication Management System”, filed Nov. 15, 1996; U.S. provisional patent application Ser. No. 60/030,996, entitled, “Remote Home Page Authoring System”, filed Nov. 15, 1996; U.S. provisional patent application Ser. No. 60/038,411, entitled, “Server-Sided Technology for Remote Television Computerization”, filed Feb. 18, 1997; U.S. provisional patent application, Ser. No. 60/055,782, entitled, “Server-Sided Internet Based Operating System”, filed Aug. 15, 1997; U.S. provisional patent application, Ser. No. 60/057,256, entitled “Server-Sided Web Based Operating System and Desktop Manager,” filed Aug. 29, 1997, and U.S. provisional patent application, Ser. No. 60/060,612, entitled “Server-Sided Internet-Based Platform Independent Operating System and Application Suite,” filed Oct. 1, 1997, all of which are pending and are incorporated herein by reference.

### BACKGROUND OF THE INVENTION

The evolution of the computer industry has been from mainframes, where all users have to take turns running software programs on a central computer system from “dumb” terminals on their desks, to smart and powerful desktop personal computers (PCs) in which users run all the software either from a removable disk or loaded onto their hard drive. The advantages of mainframes include greater processing power and the ability to centralize software programs, such as graphics programs, financial packages, etc., so that the programs can easily be maintained and updated. The disadvantages of mainframes include higher cost for installation and maintenance, and the fact that users have to take turns using processing time.

Desktop personal computers are not ideal for all users either. As users have demanded numerous enhanced features from software programs for their personal computers, it has become increasingly impractical to run such programs from removable disks. For example, a typical word processing program fills several disks, even in a compressed format. This large size, combined with distribution challenges and costs, may make it impractical and not cost-effective to upgrade the programs on a frequent basis. Also, the software programs have to be installed by each user on their own PC, which can be challenging for beginning and novice users. Moreover, mass-market programs cannot easily be customized for each user's particular needs. An additional disadvantage of PCs is that they are not very mobile, and powerful laptops carry a hefty price tag.

Another option is a PC network. Networks of PCs, typically in an office setting, have allowed key programs to be run from a central server without requiring users to take turns using the software. However, if a user wishes to be able to run several different programs simultaneously, and to switch between the programs at will, he or she will need to have a powerful operating system installed on their computer, such as the MICROSOFT WINDOWS operating system, which takes up a significant amount of storage space on the hard drive.

One of the most significant developments in the computer industry in the past decade has been the phenomenal growth of the number of users on the Internet and the World Wide Web. Many new computer users now want to view other Web sites, to create and manage their own Web sites, and to review and send electronic mail messages. A user could purchase Web authoring software and learn programming language to create these Web site files. A user also could learn how to send and maintain these Web site files using software such as FTP loaded onto their computer. A user could either maintain an account with one or more on-line service companies, such as AMERICA ON-LINE or COMPUSERVE, or they could maintain an account with an Internet Service Provider (“ISP”).

If the Web site account is maintained on-line, then the user typically can only maintain the Web site at a computer terminal on which the proprietary authoring software and FTP configuration for that particular on-line service had been installed (“client side software”). This reduces mobility and accessibility for the user. In addition, if the user decides to switch to a different on-line service, or otherwise to terminate the account with the on-line service, the user usually will no longer own the original Web site (or e-mail) address after the original on-line service account is closed. Moreover, the user has to invest in an expensive desktop PC with power and storage capacity that seems disproportionate in relation to the user's intended purpose, i.e., to view Web pages and send e-mail. Instead of a PC, a user might wish to buy a less-expensive non-computer device, such as an internet telephone, a pager, a beeper or a cell phone, or a hand-held or palm-sized personal information manager such as the PALMPILOT sold by 3COM (formerly U.S. ROBOTICS). Alternatively, a user might wish to purchase a set-top box, such as WEBTV, which is manufactured by TECHNAMA, BATRA, and COOLOGIC, among others. None of the software on the application programs on the market today, such as WORDPERFECT, MICROSOFT WORD, etc. can run on these noncomputer (“NC”) appliances. Yet all of these NC appliances may be configured to allow a user to access the Internet. The problem is the limits on what the user can do when they get there using an NC appliance.

### SUMMARY OF THE INVENTION

The systems and methods described herein provide different types of Web authoring, Web site management, and communication software technology, including but not limited to full multimedia authoring, online libraries, sounds, forms, e-mail, facsimile, voice-mail, pager, telephone, financial management, true document printing (as opposed to screen printing), text-to-voice and voice-to-text conversion, file management, spreadsheets, all accessed and run via the Internet. The system resides entirely on an Internet Web Server site and interacts with users via conventional programming languages written for a universal protocol. As a result, there is no need for client-side messaging software. All software is provided on the server side. The only software the user needs is any form of Web browser and a communications connection. Because the system is platform and operating system independent, a user may author, create, maintain, edit, send, copy, receive, save, delete, and respond to messages from any platform, using any conventional operating system. A user also could author, create, maintain, edit, copy, save and delete a Web site or a portion thereof. A user may customize their desktop configuration and may run a variety of different applications. Moreover, a user may switch between applications, and transfer text, graphics, or sound files between applications.

A remote communication management system according to the systems and methods described herein includes a server computer having memory, wherein the server computer includes a processing mechanism for receiving signals representing a message from a communications network, converting the signals into a data file, and storing the data file in the memory, a client device adapted for transmitting and receiving signals from the communications network, a communications connection between the server computer and the client device, an access control mechanism connected to the server computer for determining access rights to the data file stored in the memory of the server computer, and a server signal mechanism connected to the server computer and responsive to the access control mechanism, for receiving signals from the client device and for sending signals to the client device, via the communications connection, for generating markup language page signals representative of the data file, wherein the processing mechanism, the access control mechanism, and the server signal mechanism permit a user of the client device to view, edit, delete, reproduce, or retransmit, or some combination or variation thereof, certain of the data files via interaction with the markup language page signals.

The client device may be selected from the following group of devices, for example: mainframe computers, desktop personal computers, such as, for example, IBM, IBM-compatibles, and MACINTOSH, laptop personal computers, network computers, Internet telephones, pagers, mobile phones, hand-held personal information managers, non-computer (NC) appliances, cable television boxes, television sets, and set-top boxes, or some combination or variation thereof. The client device preferably should include a full or a partial Web browser program, such as, for example, NETSCAPE NAVIGATOR or NETSCAPE COMMUNICATOR, MICROSOFT EXPLORER, MOSIAC, or some combination or variation thereof.

The communications network may be the Internet, may be the World Wide Web, may allow communication via wireless transmissions, or may allow communication via transmissions through fiber optic lines, or some combination or variation thereof, such as, for example, electronic transmissions or radio-wave transmissions. The communications connection may be the Internet or the World Wide Web. The communications connection may allow communication via wireless transmissions, through fiber optic lines, through electronic transmissions, or through some combination or variation thereof. The remote communication management system may include a registration mechanism connected to the server computer for storing, accessing, and, optionally, modifying a list of names of registered users, which could include, for example, individuals, corporations, families, members of particular communities, or shared-interest groups.

The signals received by the processing mechanism of the server computer may represent an electronic mail (e-mail) message, which may include an address field. The processing mechanism may then determine whether the address field includes the name of a registered user. The access control mechanism may allow only the registered user to whom the e-mail message is addressed to access the e-mail message. The processing mechanism may reject the e-mail message if the address field does not include the name of a registered user.

A remote information management system according to the systems and methods described herein may include a server computer having memory, wherein the server computer includes a processing mechanism for receiving signals representing information from a communications network, converting the signals into a data file, and storing the data file in the memory, a client device adapted for transmitting and receiving signals from the communications network, a communications connection between the server computer and the client device, an access control mechanism connected to the server computer for determining access rights to the data file stored in the memory of the server computer, and a server signal mechanism connected to the server computer and responsive to the access control mechanism for receiving signals from the client device and for sending signals to the client device, via the communications connection, for generating markup language page signals representative of the data file, wherein the processing mechanism, the access control mechanism, and the server signal mechanism permit a user of the client device to view certain of the data files via interaction with the markup language page signals.

The client device may be selected from the following group of devices: mainframe computers, desktop personal computers, laptop personal computers, network computers, Internet telephones, pagers, mobile phones, hand-held personal information managers, non-computer (NC) appliances, cable television boxes, television sets, and set-top boxes.

A registration mechanism may be connected to the server computer for storing, accessing, and modifying a list of names of registered users. The information is sent by a third party and addressed to a registered user. The information may be sent by a registered user and addressed to themselves. The information may include information sent by a registered user, such as, for example, contact data, names, addresses, and phone numbers, or some combination or variation thereof, such as, for example, e-mail addresses, company names, Web site addresses, appointment or meeting dates, times, and locations, reminders, task lists, and the like.

The server signal mechanism may include a messaging device for generating markup language page signals for composing a message from the client device via interaction with the markup language page signals and for sending the message to the communications network. The message may be addressed to one or more third parties who are not registered users, or to one or more registered users, or to some combination thereof.

A method for remote communication management according to the systems and methods described herein may include providing a server computer for receiving signals representing a message from a communications network, converting the signals into a data file, and storing the data file, providing a client device for transmitting and receiving signals from the communications network, connecting the server computer and the client device via a communications connection, receiving signals from the client device, sending signals from the server computer to the client device for generating markup language page signals representative of the data file, and determining access rights to the data file, thereby allowing a user of the client device to view, edit, delete, copy, retransmit, save, or some combination or variation thereof, the data file via interaction with the markup language page signals if the user is allowed access rights to the data file. Such a method may further include providing a registration process for allowing users to request registration on the system and for storing a list of registered users. Receiving signals representing a message may include receiving signals representing an electronic mail (e-mail) message, which may include an address field. A method of remote communications management may further include determining whether the address field includes the name of a registered user, allowing the registered user to whom the e-mail message is addressed to access the e-mail message, and rejecting, i.e., returning, deleting, or both, the e-mail message if the address field does not include the name of a registered user, further including allowing the user of the client device to compose a message via interaction with the markup language page signals and to direct the server computer to send the message to the communications network.

### BRIEF DESCRIPTION OF DRAWINGS

FIG. 1 is a schematic diagram illustrating an embodiment of a server-sided Internet based operating system according to the systems and methods described herein.

FIG. 2 shows a block outline of the INERGY 2000 operating system. The outline shows the features that may be included in the basic package, as well as add-on functionality that may be added.

FIG. 3 is a schematic illustration of the Website Design Studio, and shows that the application may also be connected to the FILE MANAGER, the WEBWRITER, and the spell checker, for example.

FIG. 4 is a schematic diagram that illustrates the WEBWRITER program, and includes examples of some of the editing features that may be available, as well as optional connections to other applications, such as E-MAIL AMERICA, and to tools such as FILE MANAGER and File Conversion. Printing, faxing, and connections to other servers also are shown.

FIGS. 5 through 48 show examples of Web screen shots and the corresponding HTML source code for such screens, according to an embodiment of the systems and methods described herein.

FIGS. 49 through 66 show examples of Web screen shots according to an embodiment of the systems and methods described herein.

Certain of the attached drawings show examples of program language according to one embodiment of the systems and methods described herein. It will be understood that this is only one embodiment and that the particular implementation of such software code will vary depending on the program language used. Thus, the invention is in no way limited to this particular embodiment.

### DETAILED DESCRIPTION OF THE PREFERRED EMBODIMENTS

The systems and methods described herein provide different types of Web authoring, Web site management, and communication software technology, including but not limited to full multimedia authoring, online libraries, sounds, forms, e-mail, facsimile, voice-mail, pager, telephone, financial management, true document printing (as opposed to screen printing), text-to-voice and voice-to-text conversion, file management, spreadsheets, all accessed and run via the Internet. The system resides entirely on an Internet Web Server site and interacts with users via standard hyper-text markup language (“HTML”, which is described in Ian S. Graham, HTML Sourcebook, 3d ed. (1997) and U.S. Pat. No. 5,355,472 to Lewis and U.S. Pat. No. 5,530,852 to Meske et al.), PERL, CGI, and JAVASCRIPT programs, which are written for a universal protocol, currently HTML Standards Version 3.0. Any markup language or variation thereof may be used. The system also includes code written in UNIX, PERL, JAVA, and C++. General techniques of Internet programming are described in Kris Jamsa, Ph.D. and Ken Cope, Internet Programming (1995).

In the present system, there is no need for client-side messaging software. All software is provided on the server side. The only software the user needs is any form of Web browser, such as NETSCAPE NAVIGATOR, NETSCAPE COMMUNICATOR, MICROSOFT EXPLORER, NETCOM, MOSAIC, or any other partial browser, and an Internet, intra-net bulletin board, or other electronic communications connection or a non-computer communications connection such as one designed for use in connection with a television set, for example WEBTV.

Because the system is platform and operating system independent, a user may author, create, maintain, send and receive messages from any platform, including but not limited to IBM PC and compatible platforms, MACINTOSH platforms, and non-computers NCs or set-top boxes such as WEBTV, using any operating system, including but not limited to MICROSOFT WINDOWS, WINDOWS 95, WINDOWS NT, WINDOWS CE, DOS, and UNIX. A user may also create, receive, edit, and print documents, run financial packages, pay bills electronically, convert text-to-voice and voice-to-text, manage personal information, schedule appointments, run desktop publishing software, send and receive facsimile messages, etc.

In order to receive an account on the system, a user would register, for example, through their television, mail, telephone, facsimile, or on-line. Preferably, registration would be one time only, although periodic renewals could be required. The user could then access the system using any Internet access and Web browser, including, for example, a set-top box. No special software or particular ISP would be required. Thus, a user could create and edit their Web site, visit other Web sites, send and receive messages, access their personal information manager (“PIM”) and schedule, create, edit and send documents, faxes and voice messages, pay bills, prepare a budget, all from anywhere in the world, using any computer or device with full or partial Web browsing capability. The user would continue to receive messages, with no interruption, even if the user switched ISPs, technologies, computer terminals, or televisions, or if the user moved to a different location. The user also could access their Web site, their PIM and their personal schedule residing within their messaging system along with private messages, voice mail, faxes, etc. from any office computer with a Web browser and Internet connection. In addition, the user would not lose messages if the user's laptop or portable computer were stolen, because the messages would reside on the system's server and would be backed-up automatically.

Another advantage for the user would be that, because all system software is provided directly at the system's Web site, all enhancements are provided at a centralized location. Thus, it is not necessary to periodically provide each user with a separate or an individual copy of updated software.

The system includes additional features such as the ability to convert files received from many types of systems to HTML and text (TXT), and may be expanded to allow conversion from and to a full range of word processing or spreadsheet formats, including but not limited to MICROSOFT WORD, WORDPERFECT, RICH TEXT FORMAT, EXCEL, LOTUS, etc. The system may include support for embedded application files that includes automatically executing the corresponding application, an address book that automatically addresses a message to send when an address entry is selected, and general access to a list of registered system users. The PIM or CONTACT MANAGER feature provides the ability to create and store for global retrieval a complete listing of the user's contacts. A “schedule” feature offers the ability to create and maintain a complete 24-hour schedule of the user's activities including comprehensive connectivity to their PIM, for global retrieval. Preferably, a user, including a user with only a set-top box or an Internet phone or pager, may send a document to print. The document would go to a print server, and would then be spooled in a data stream over the Internet to the printer designated by the user, which may optionally be selected from a list of available printers. Thus, true document printing, as opposed to screen capture, may be provided.

Other features of the operating system include the ability to interface e-mail communications with facsimile, voice and multimedia communications. A preferred feature of the operating system would be to connect all of the applications to each other, which would allow users to access all of the other applications from within a particular application, optionally via the FILE MANAGER feature.

The operating system also may have security features, including but not limited to support for digital signatures, encryption, and password protection, as well as a time out feature to prevent access to the user's information if the user has not exited the service or taken any other action for an extended period of time.

The system also may have notification via telephone, facsimile, pager, or other device, when e-mail has been received. The system may have additional gateways built to offer seamless carry-over to existing corporate mail and messaging systems such as CCMAIL or PCANYWHERE.

One of many possible ways to implement they system is to use clustered DEC 64-bit alpha servers (or a server farm) to allow for safe fail-over, distribution of operating load, and scalability. In this embodiment, a UNIX operating system is used. ORACLE database and NETSCAPE Webserver programs run on the servers, and the servers are connected to the Internet through T1 or T3 lines, or other communication channel with wide-band capability.

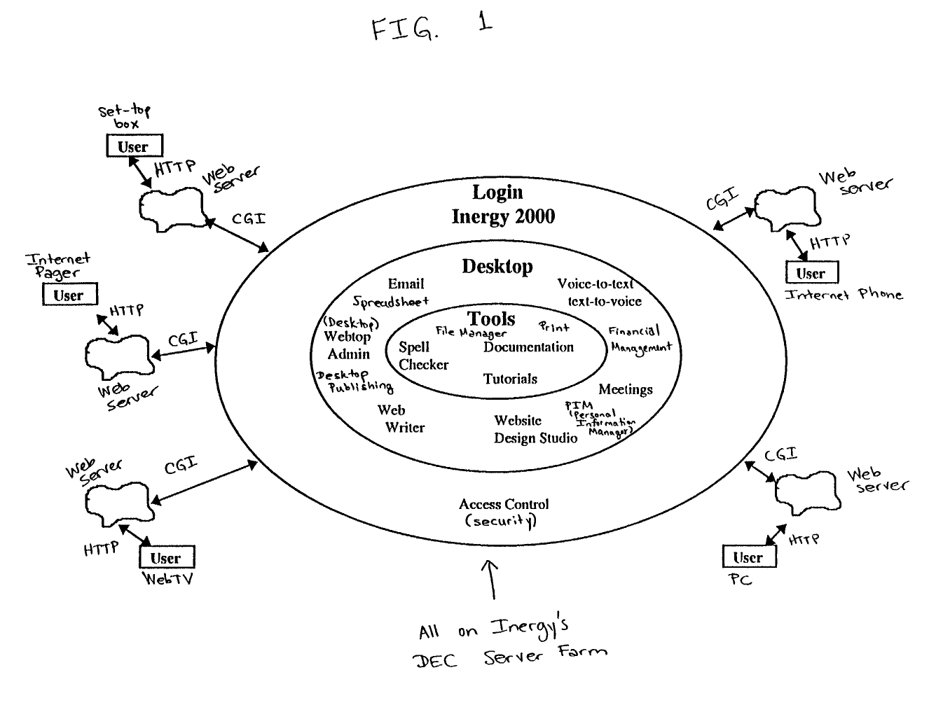

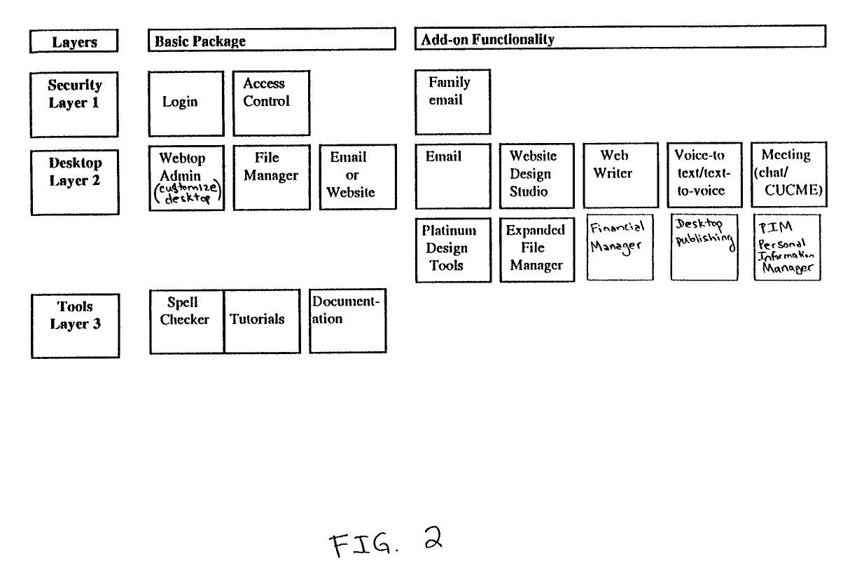

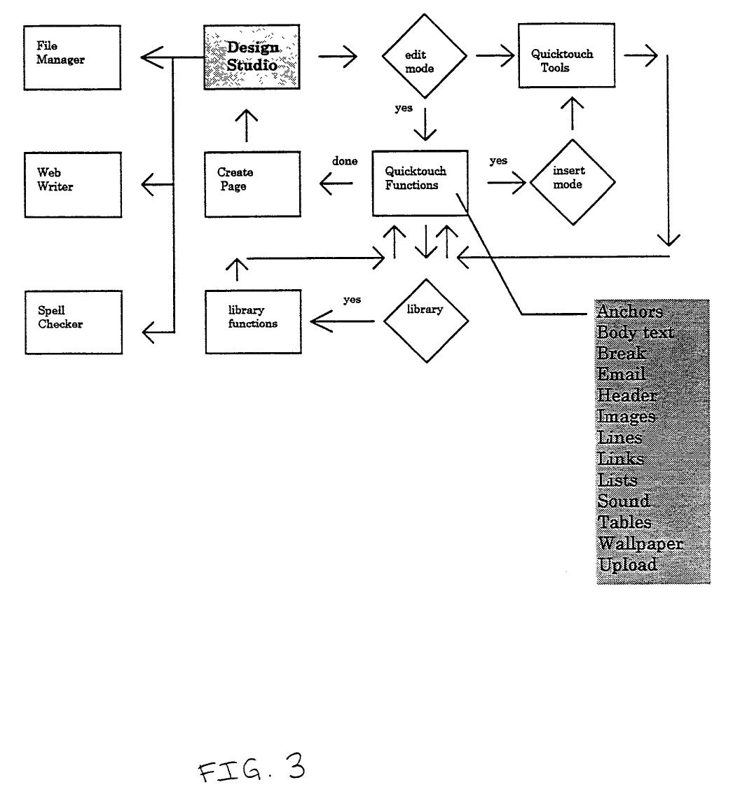

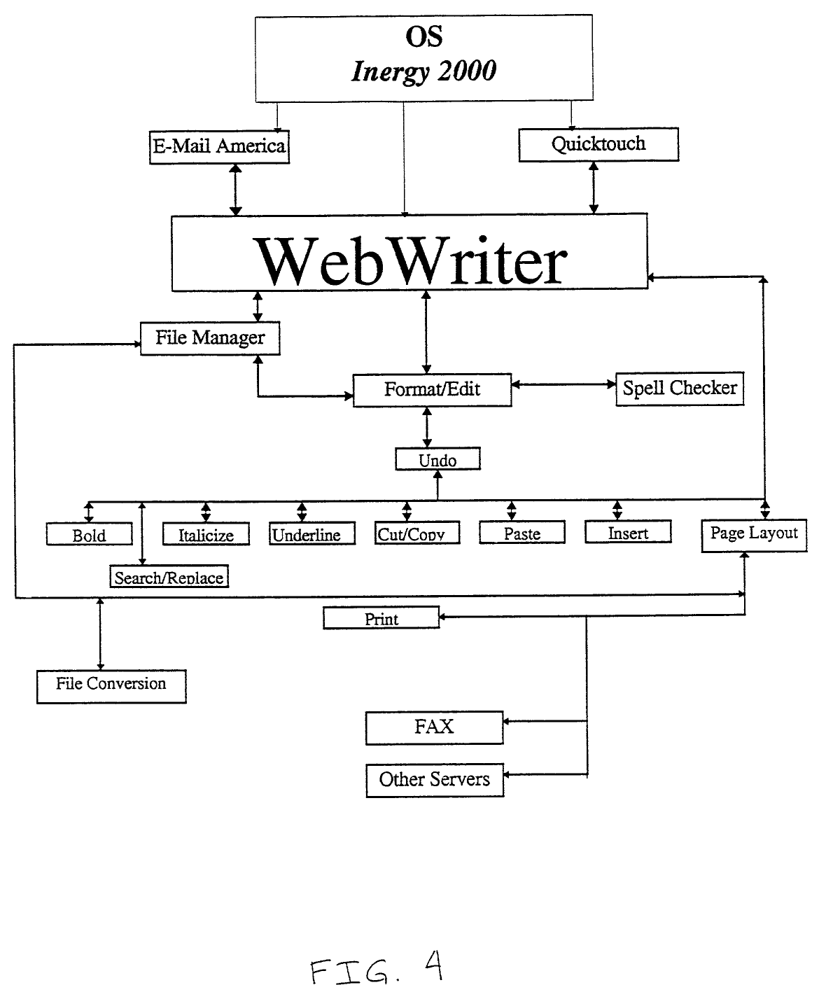

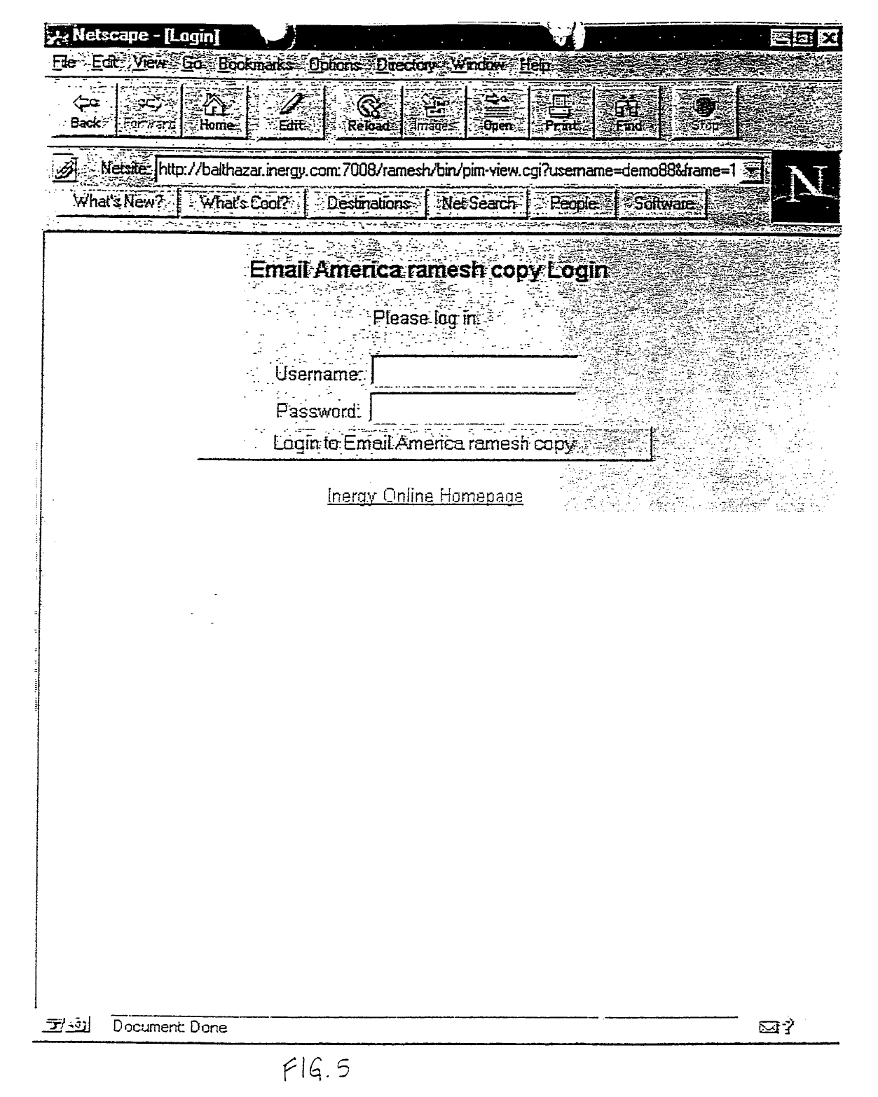

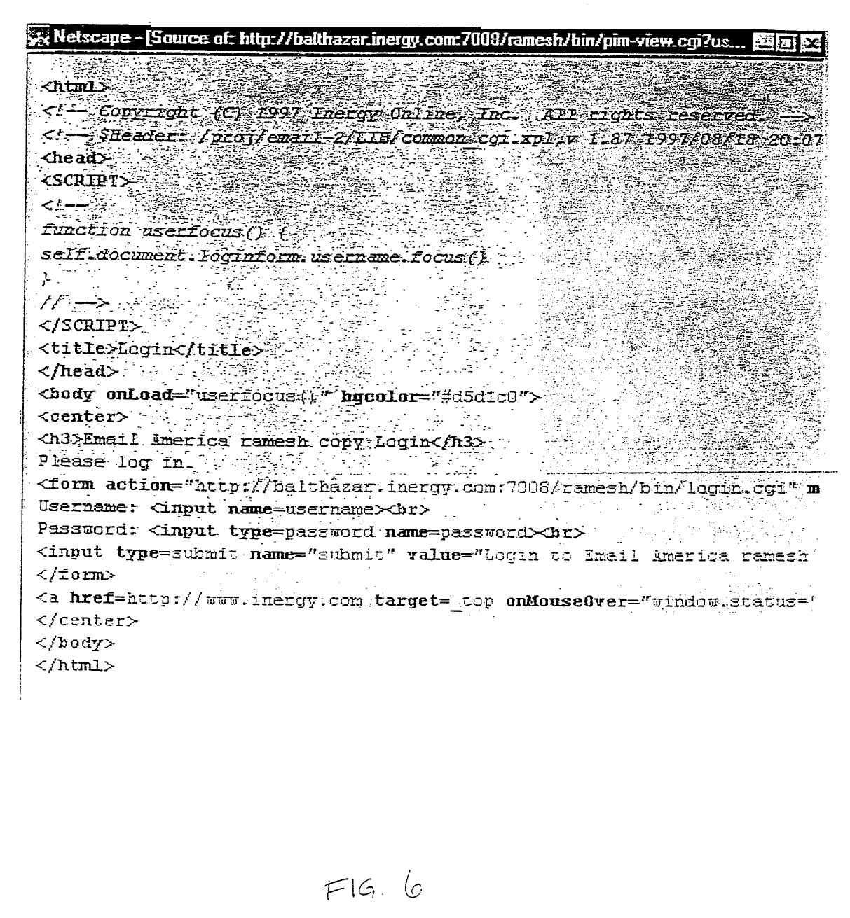

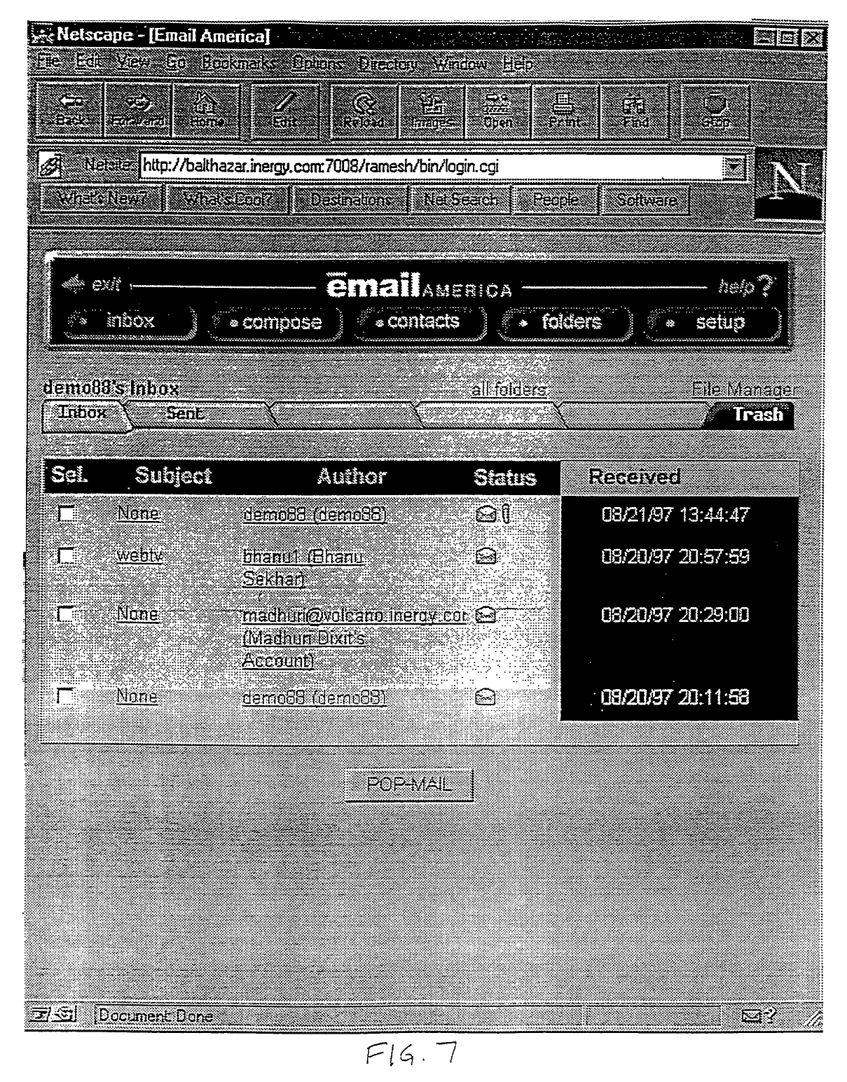

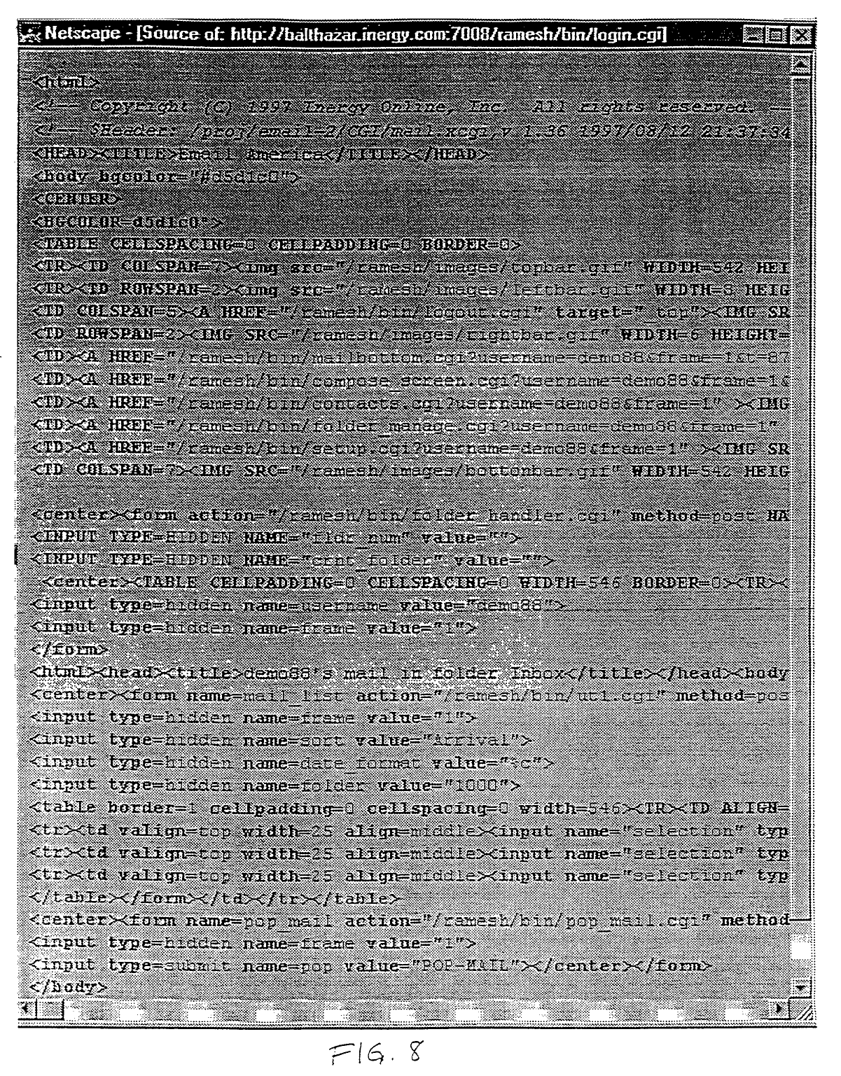

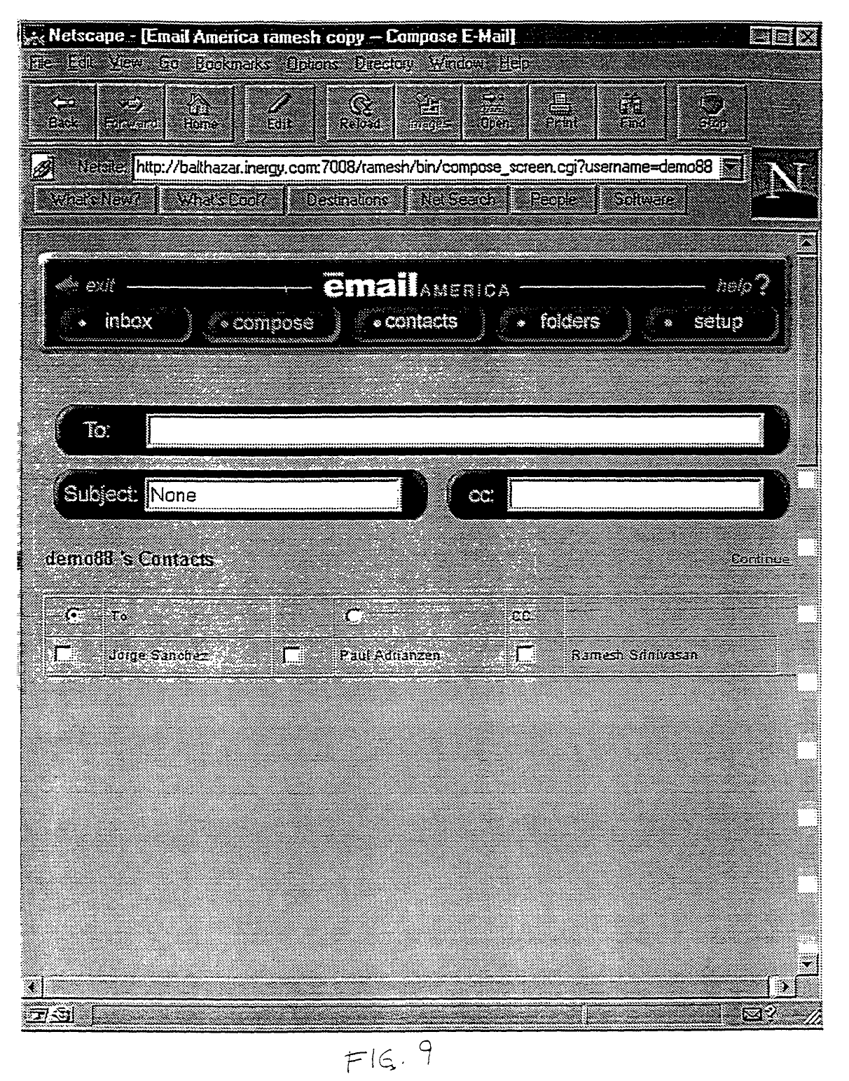

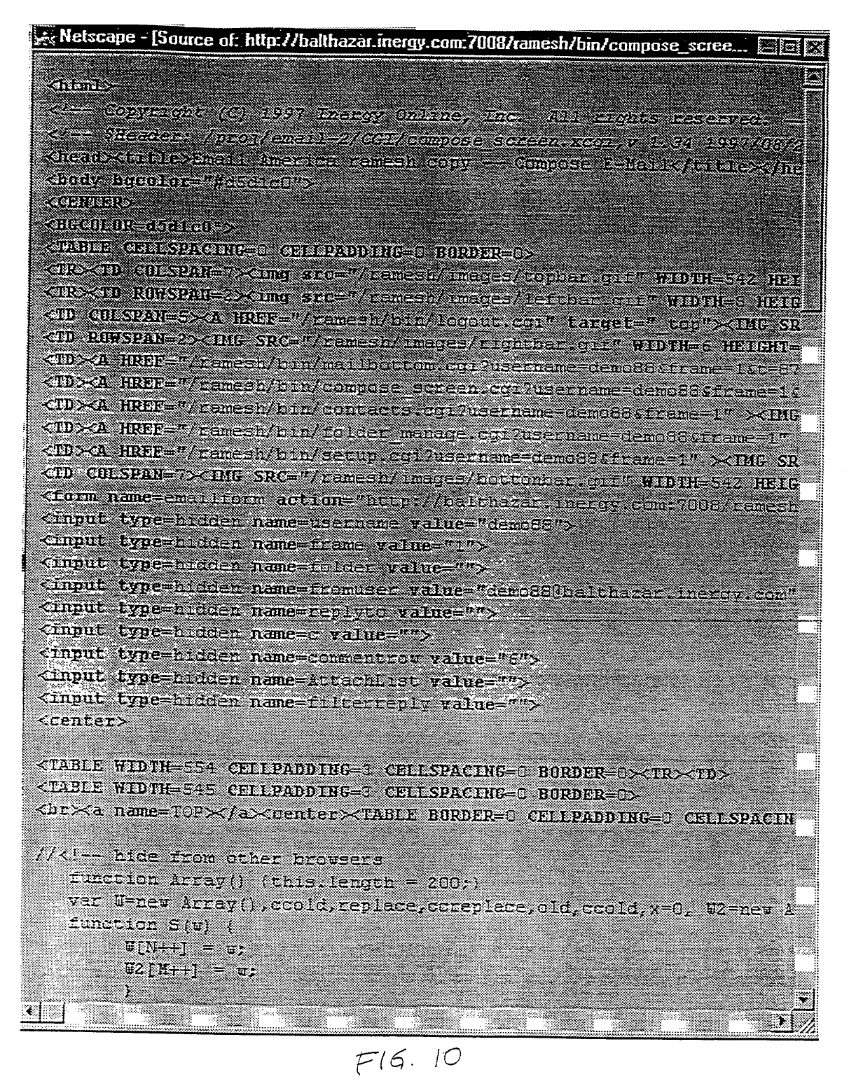

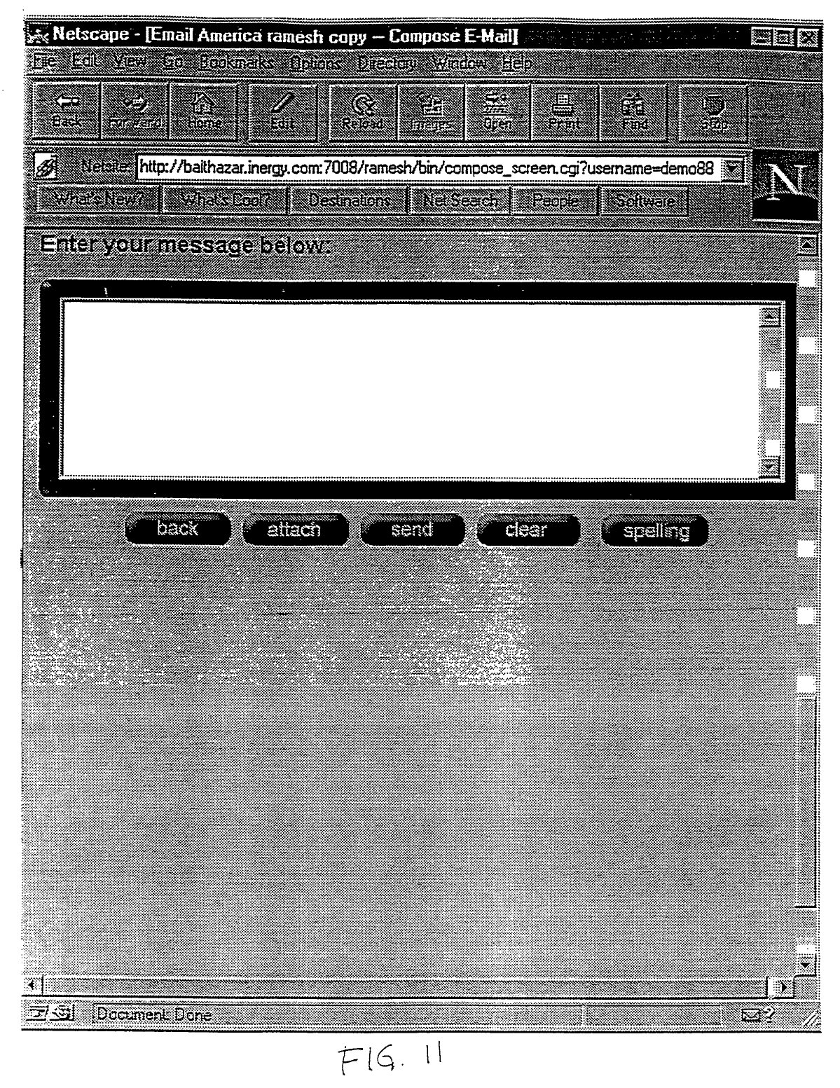

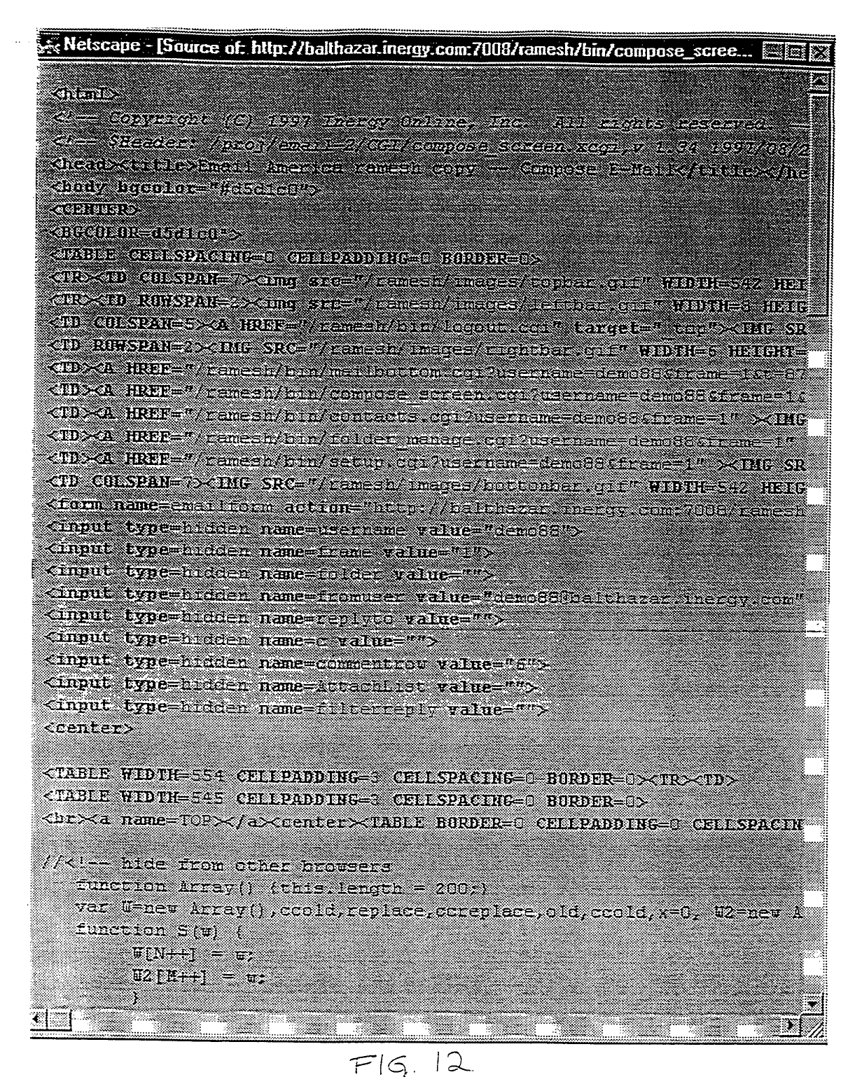

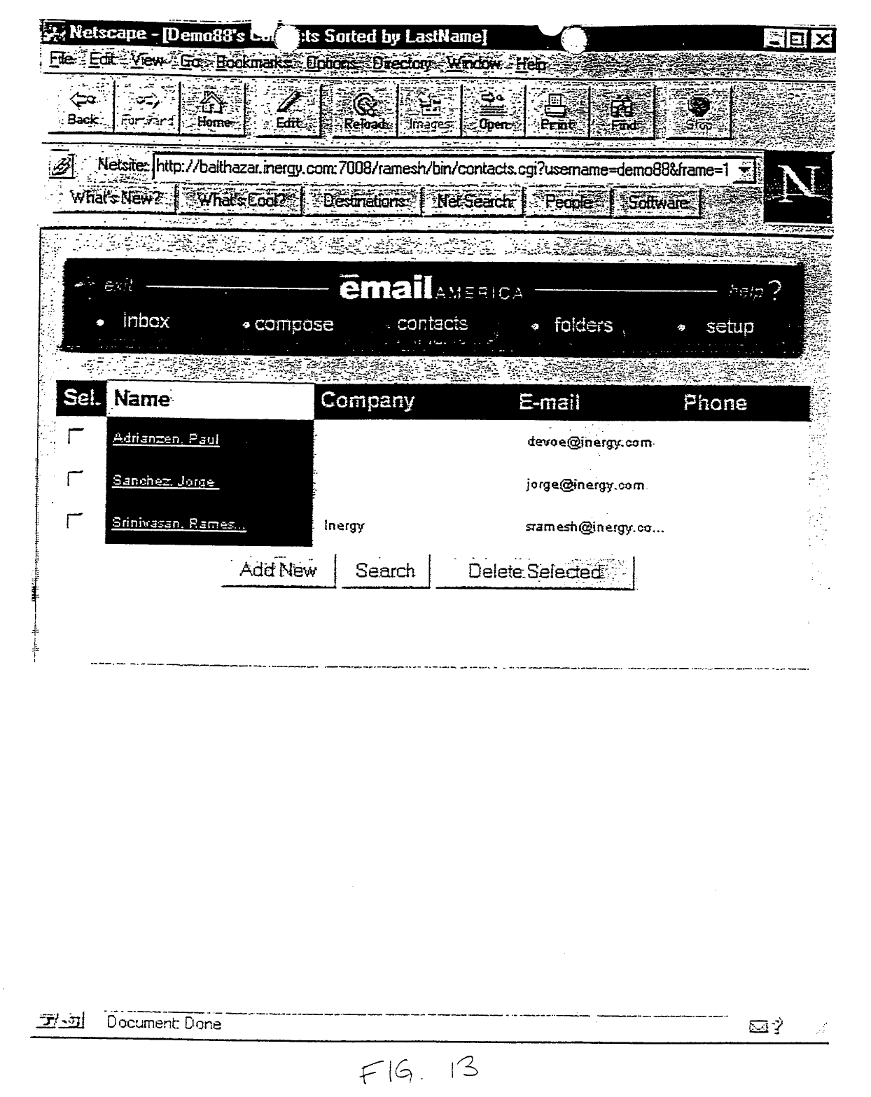

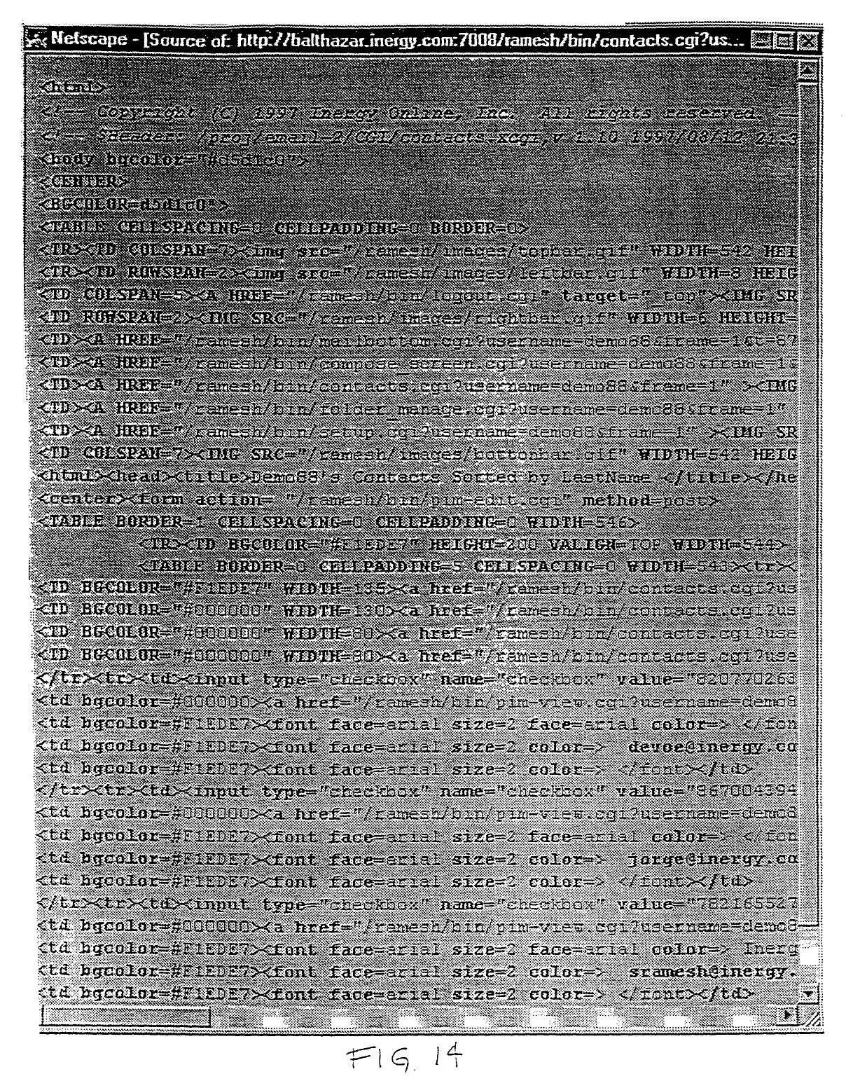

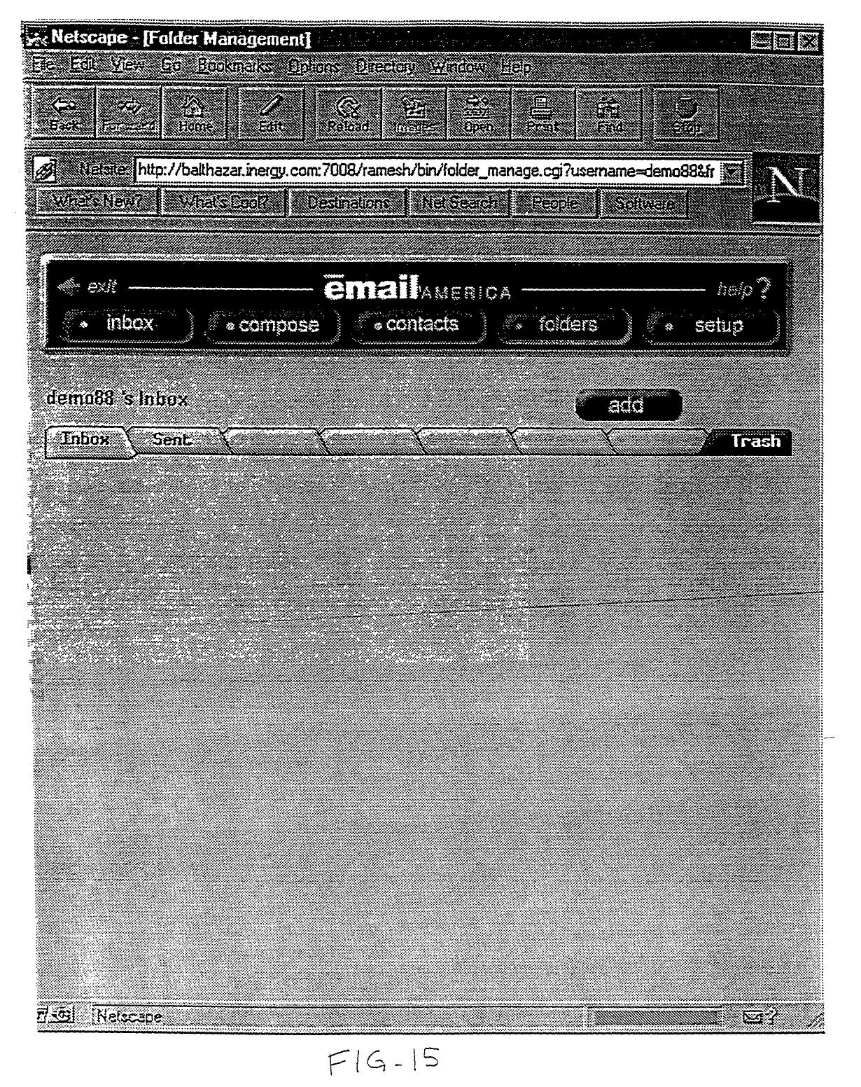

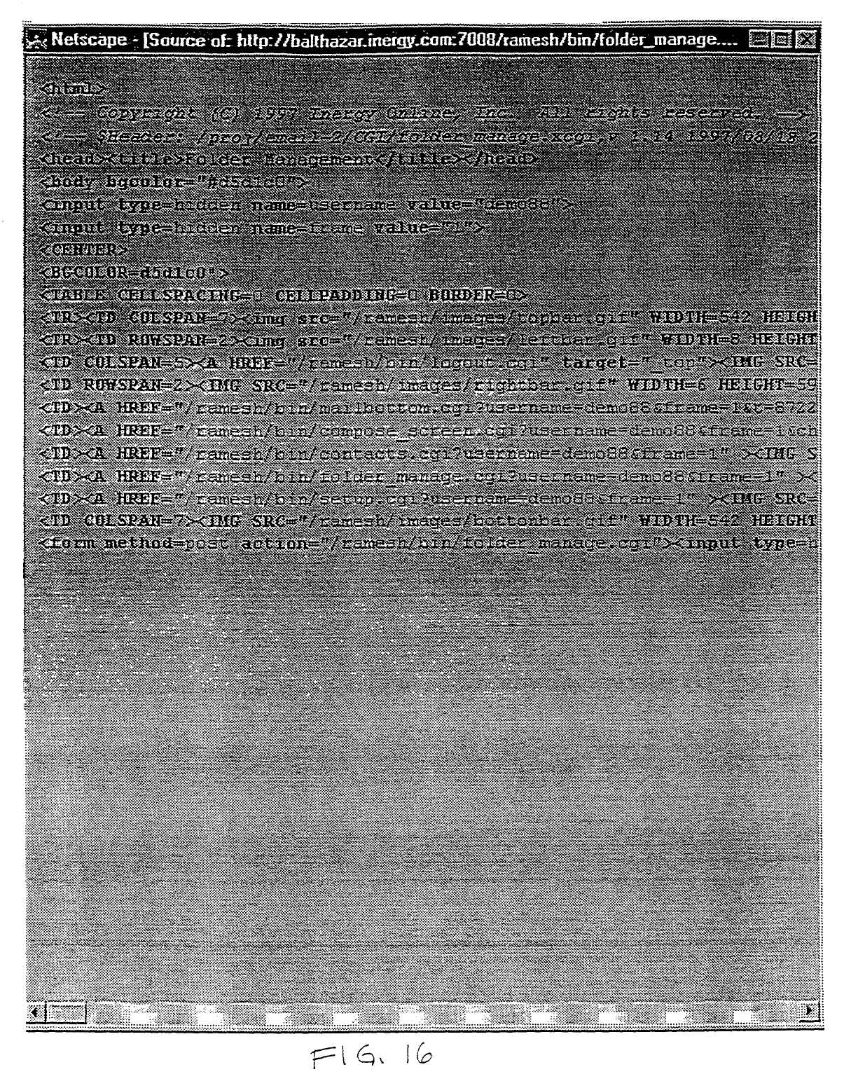

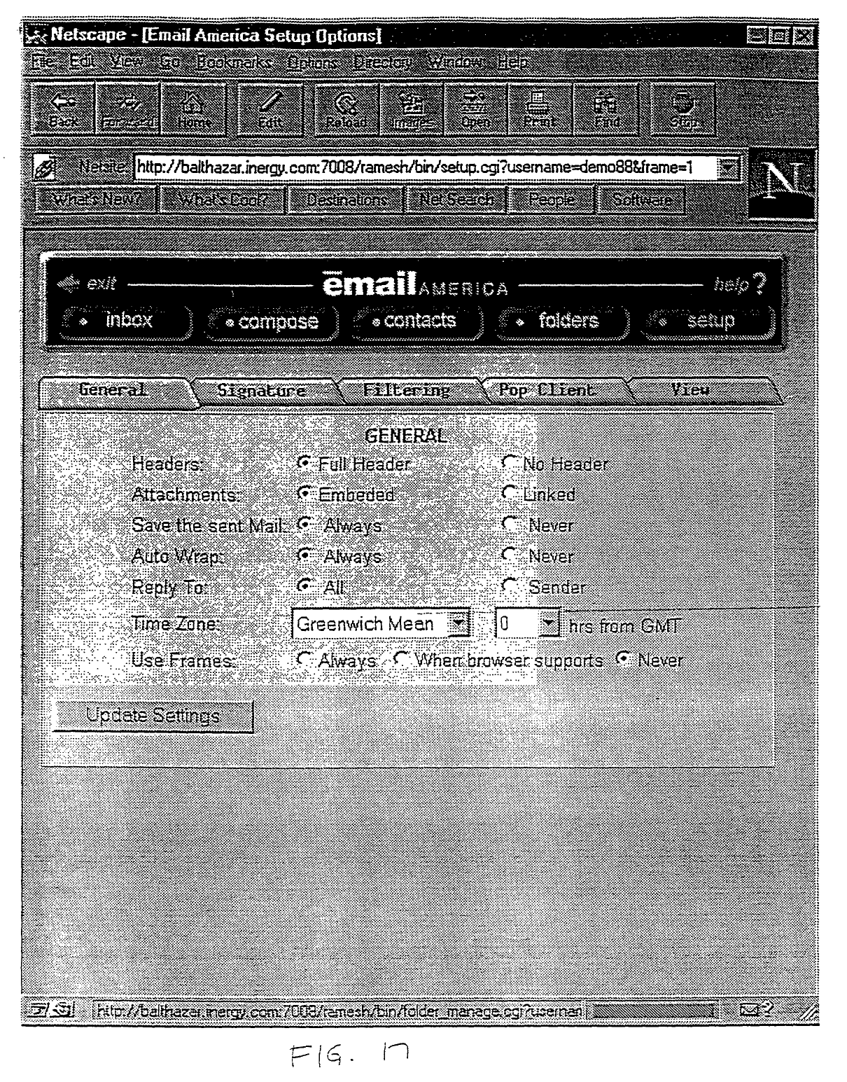

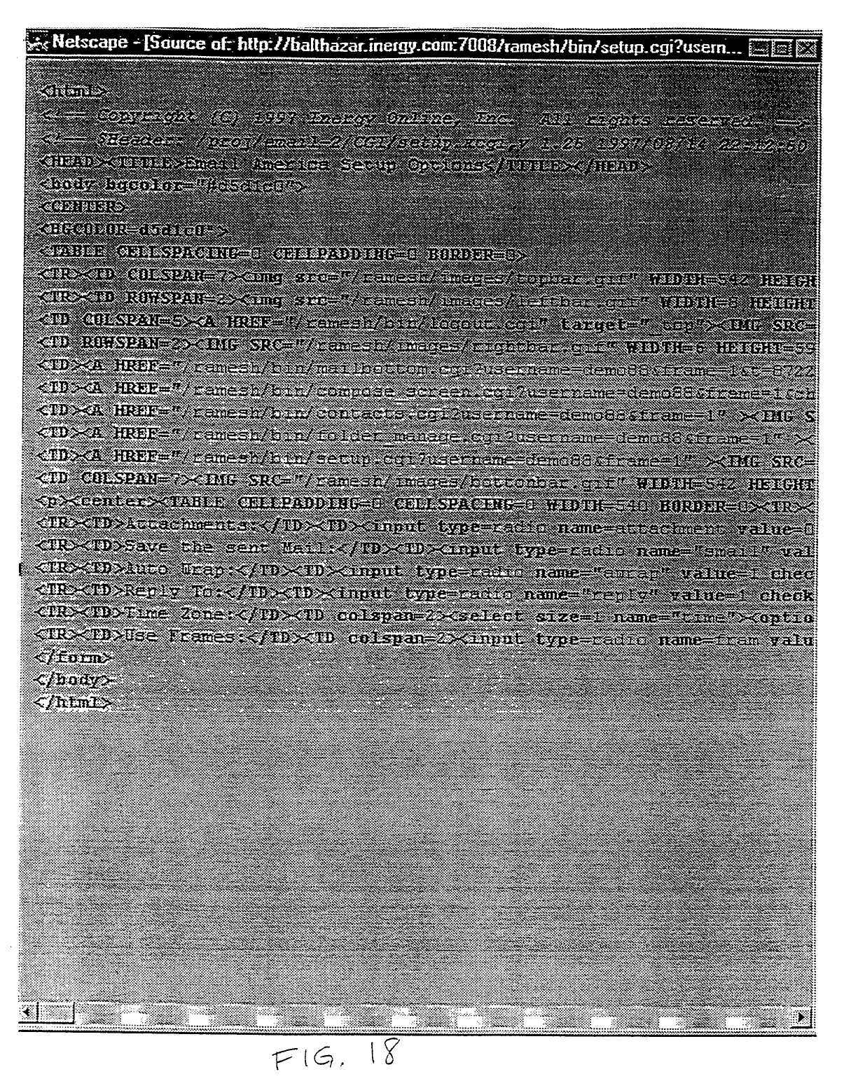

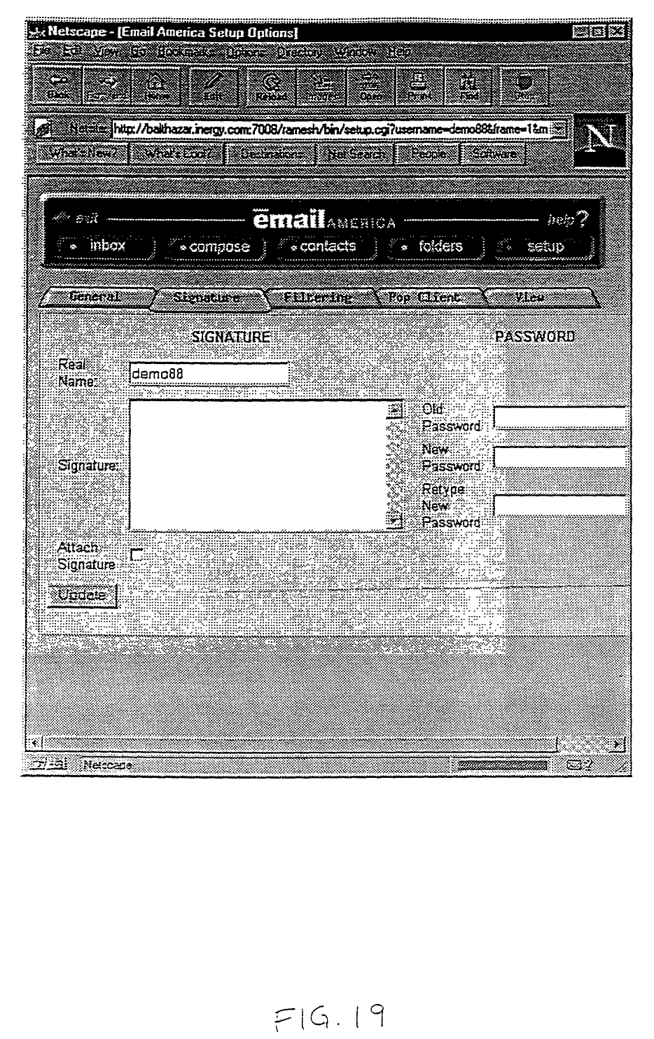

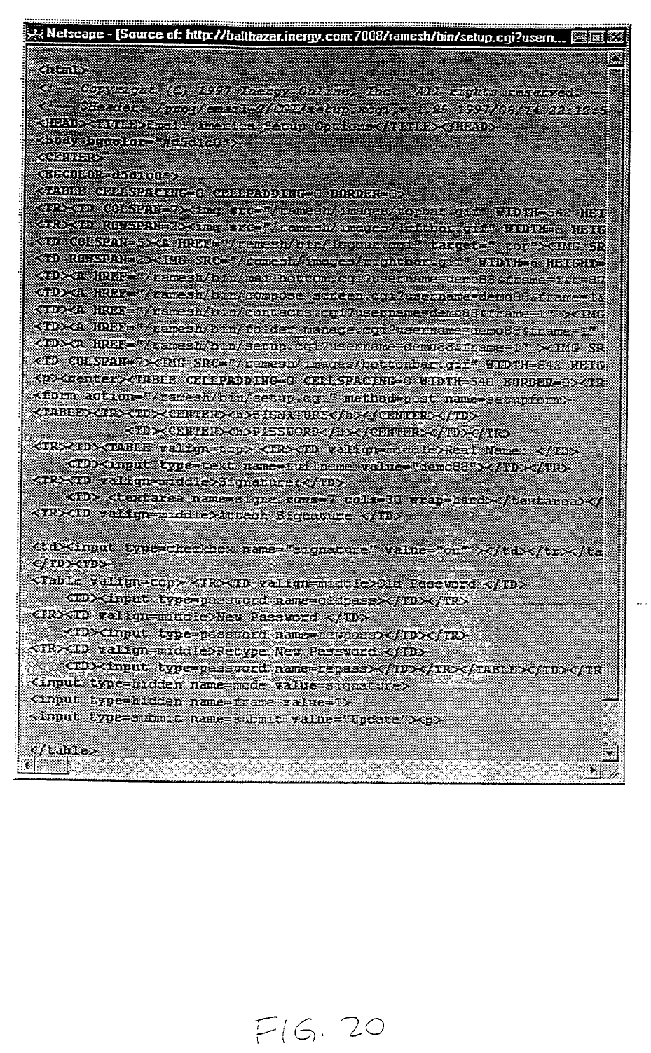

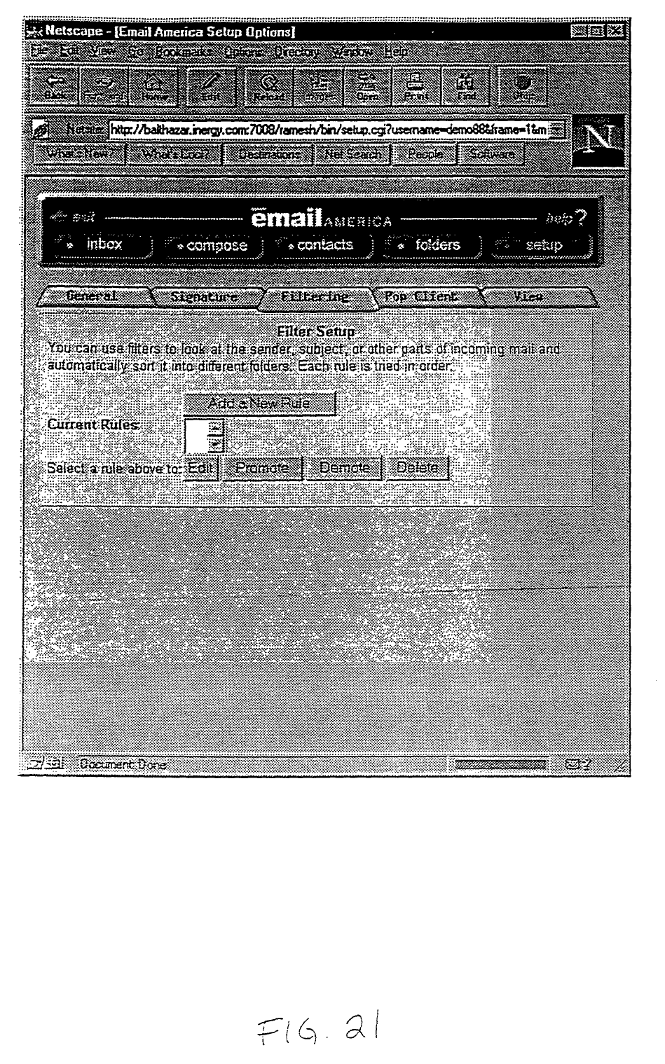

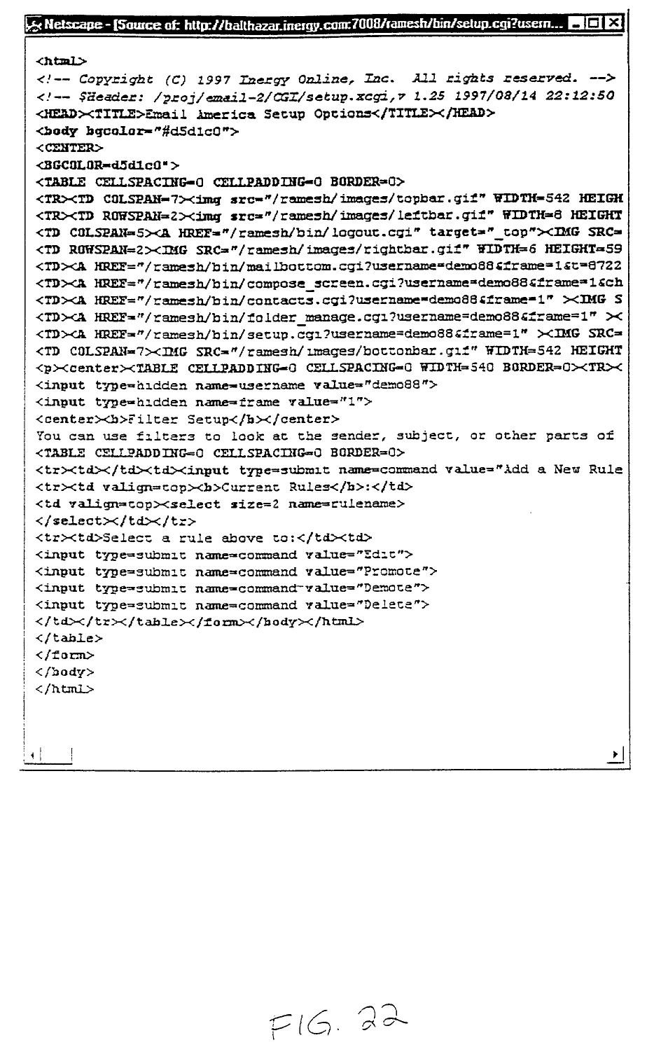

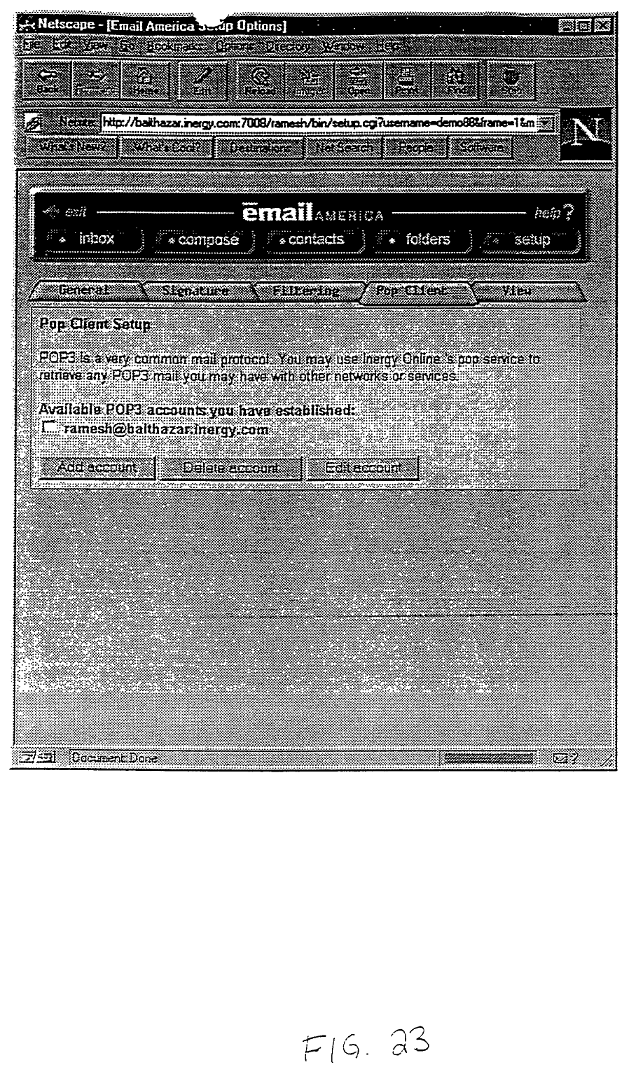

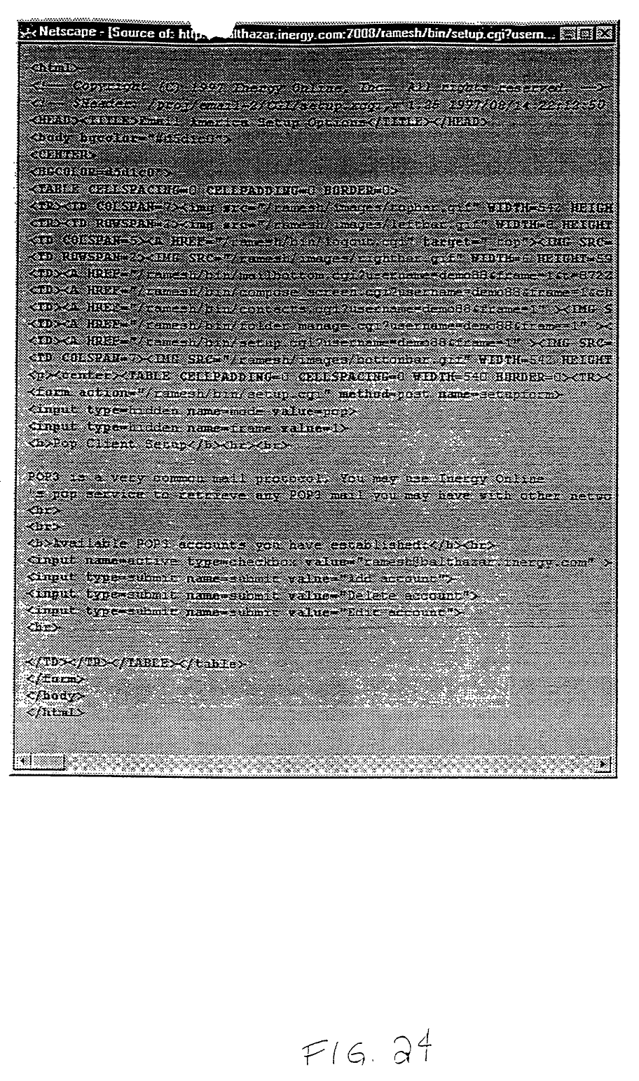

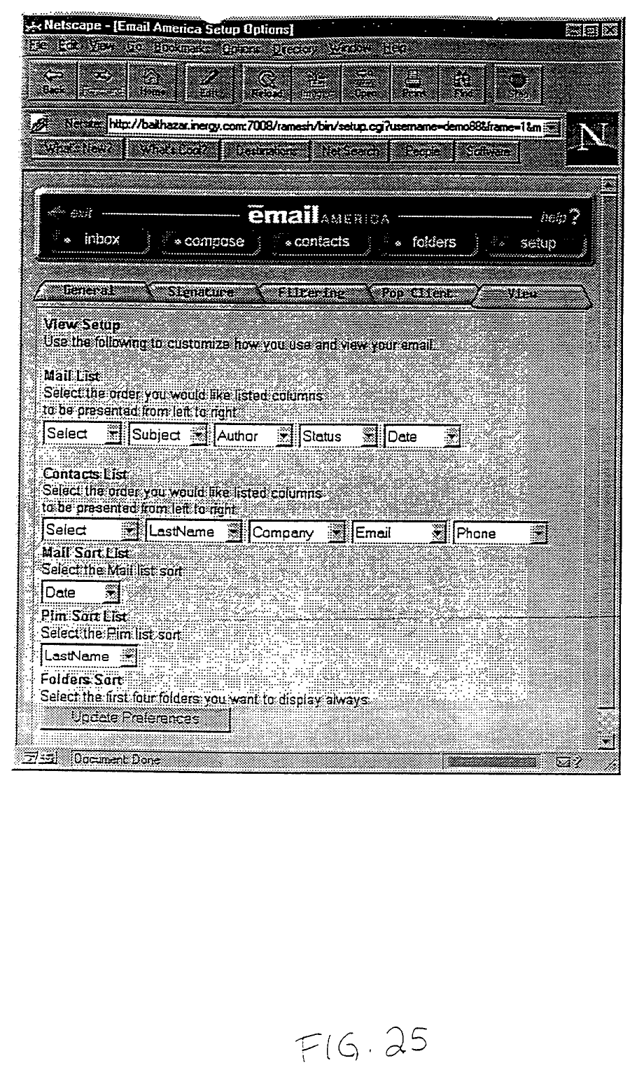

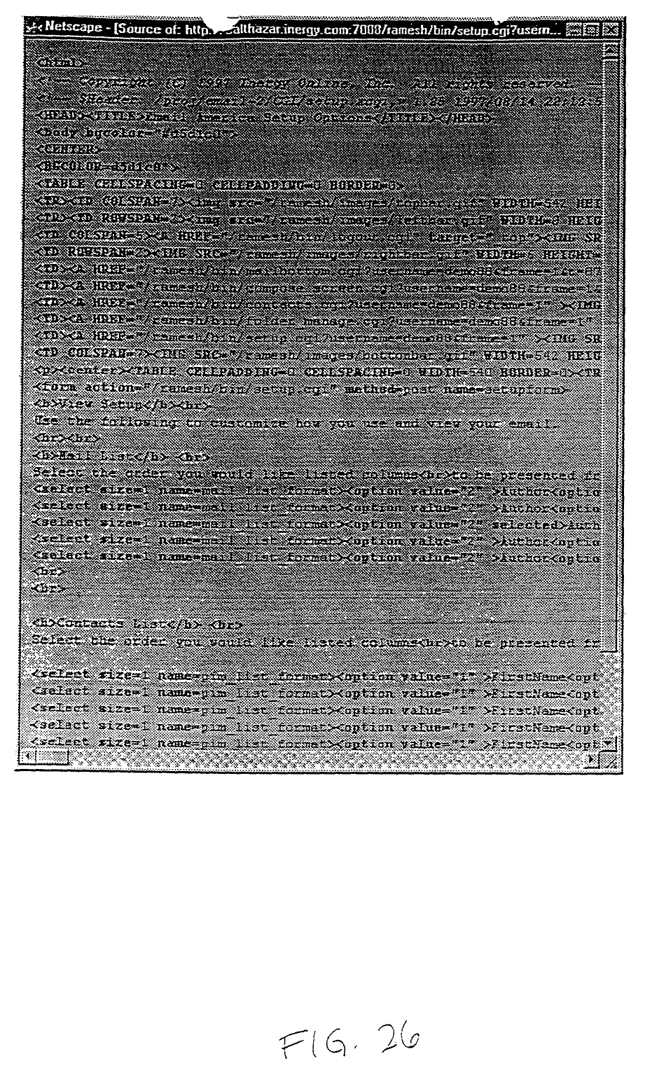

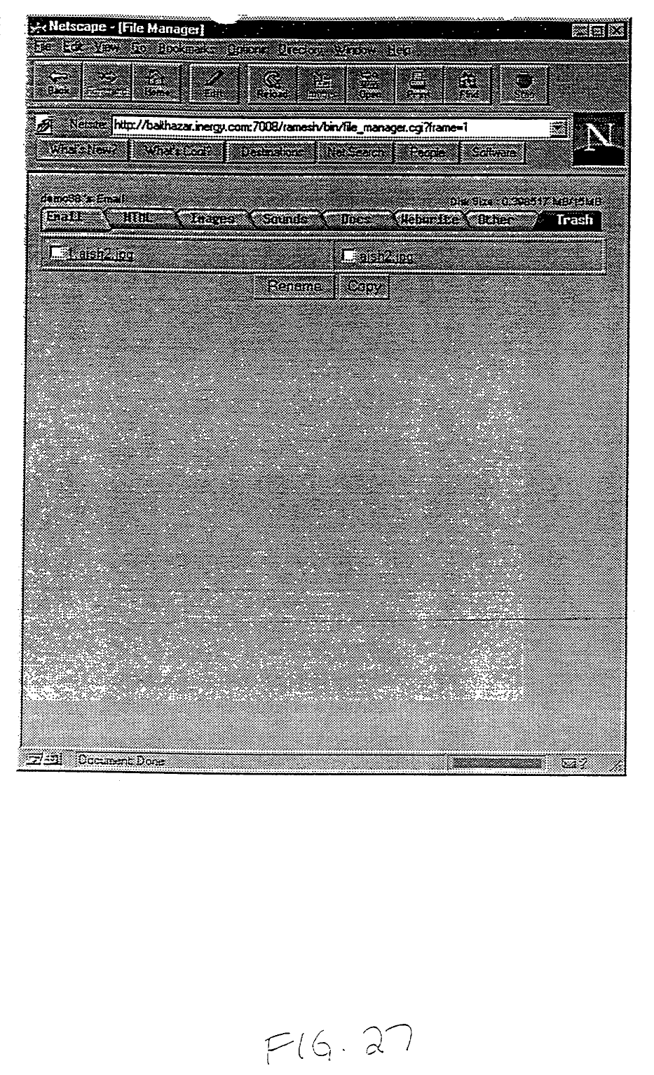

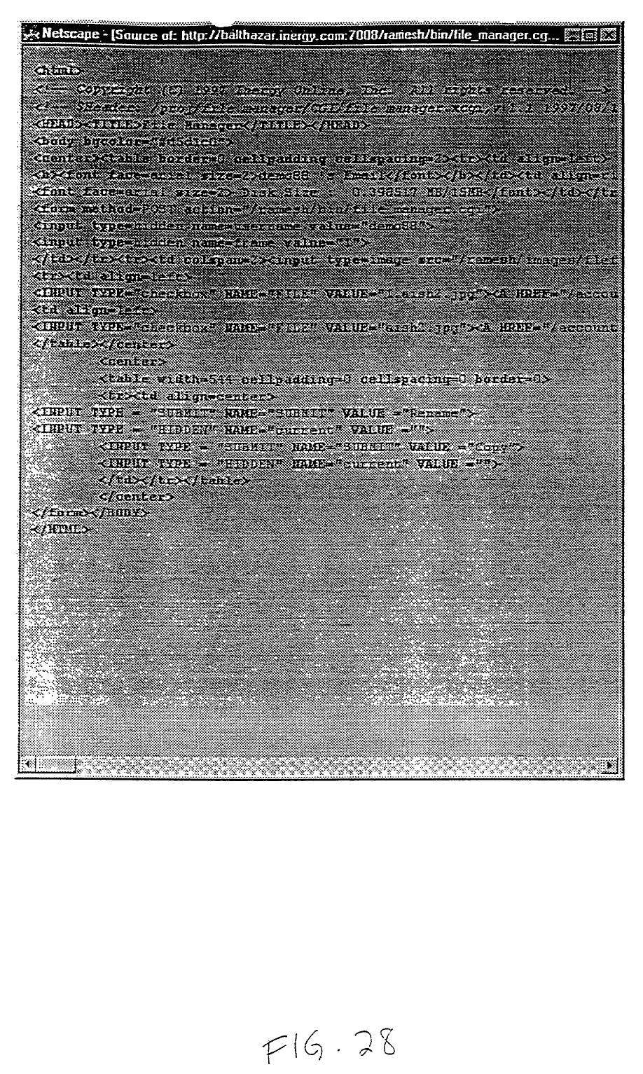

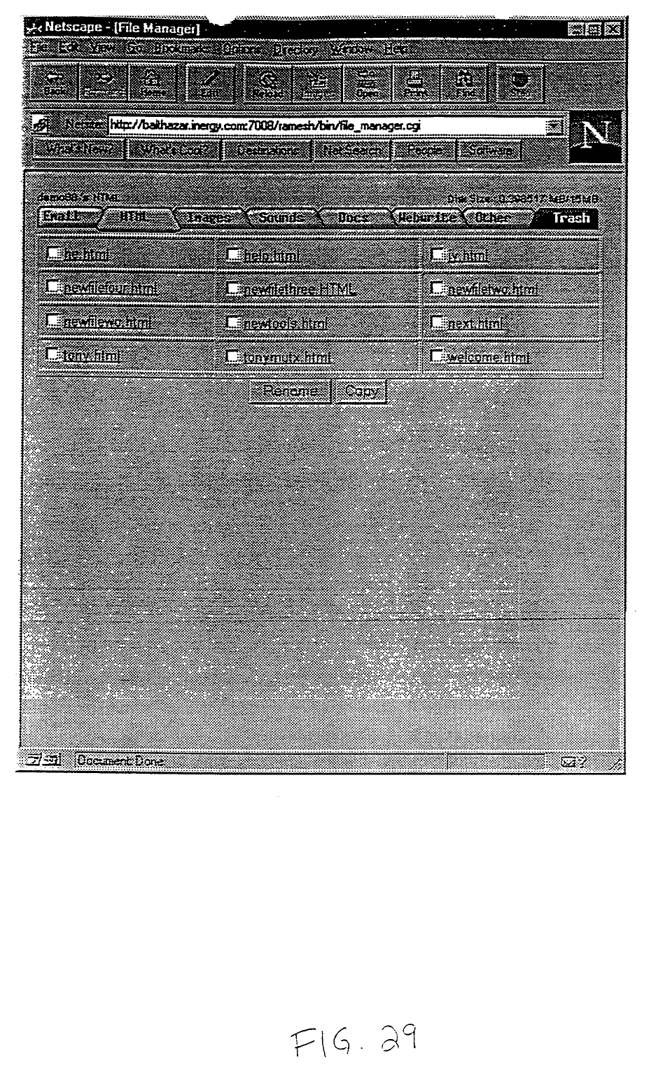

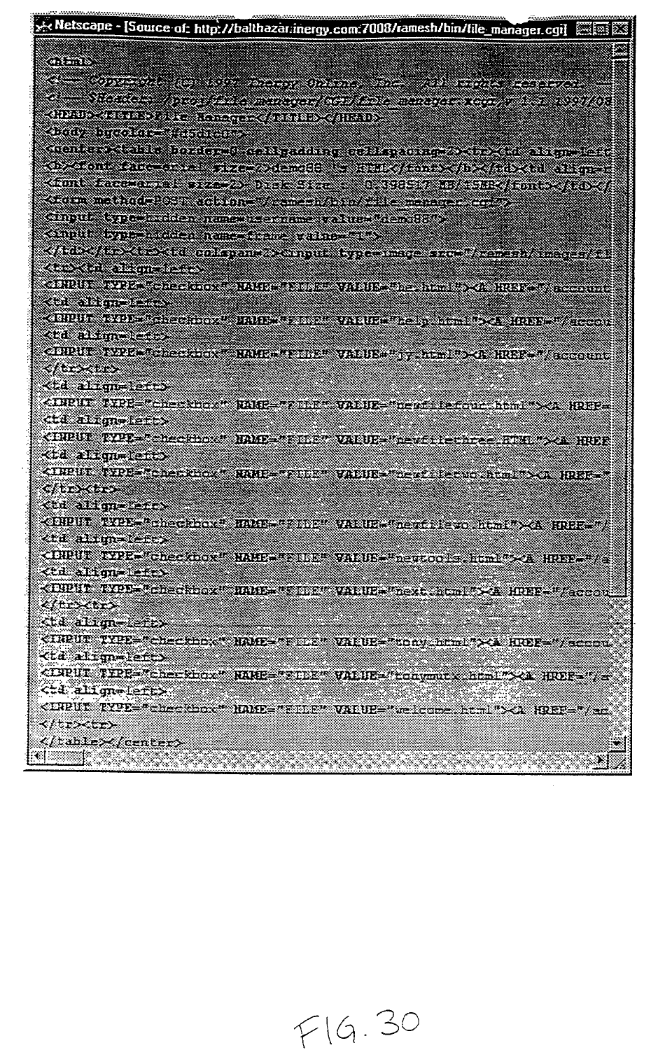

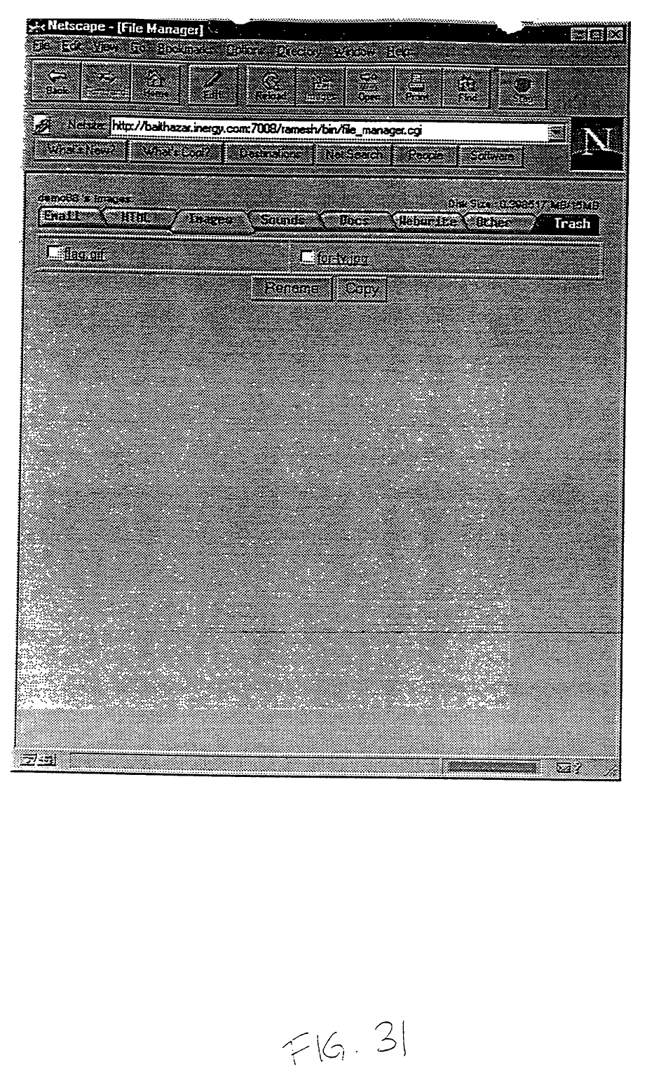

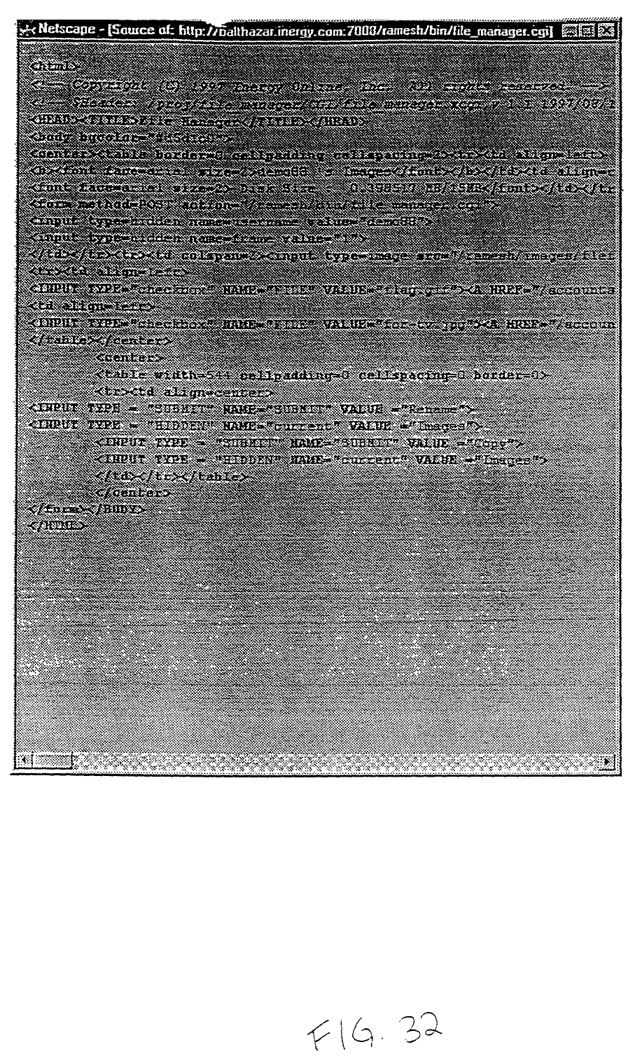

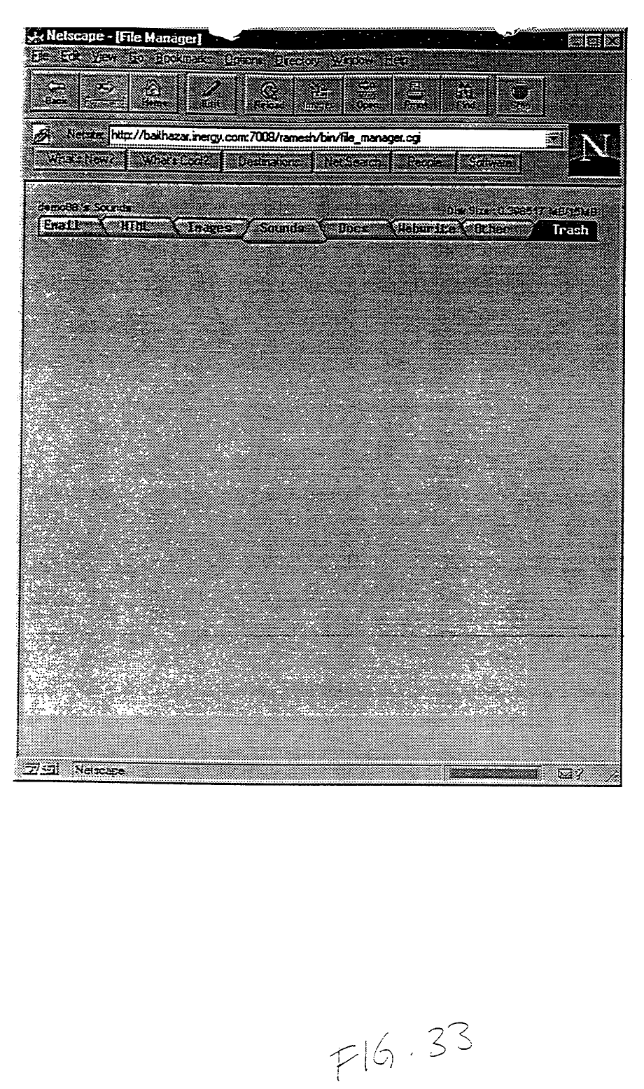

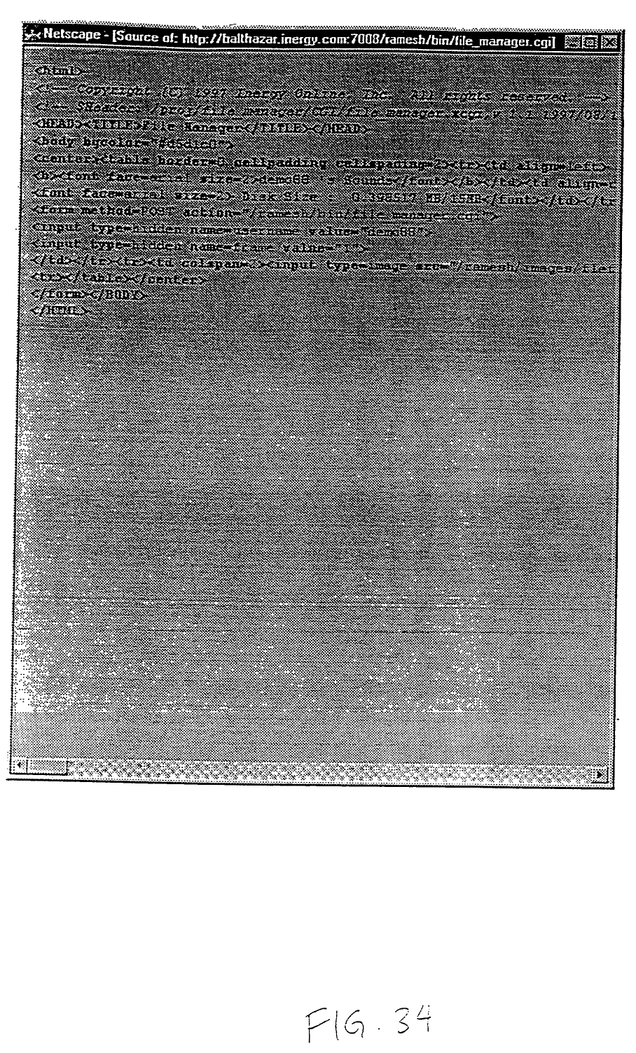

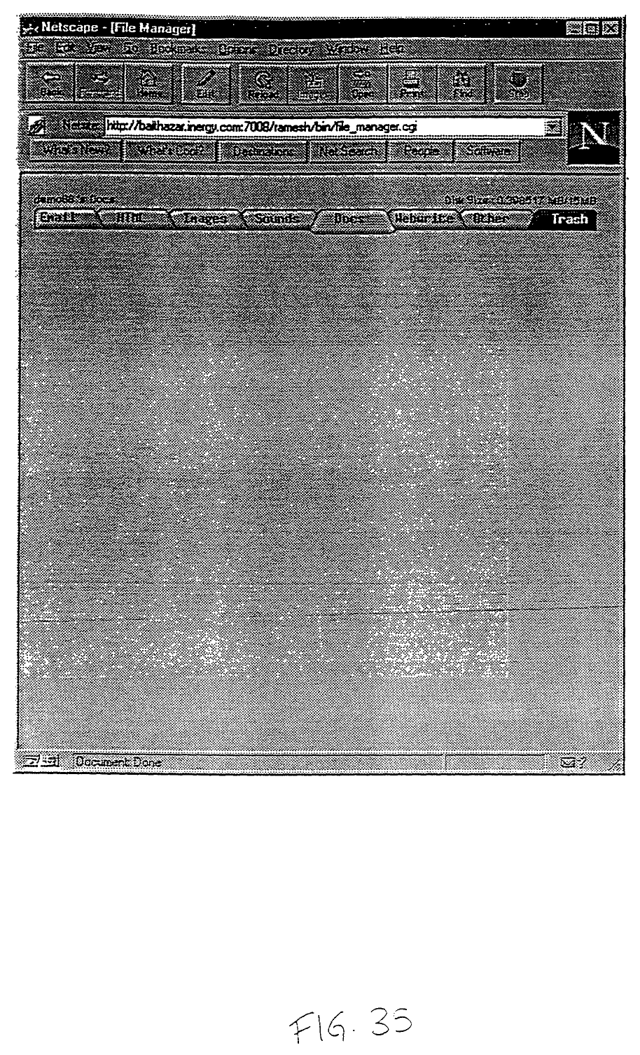

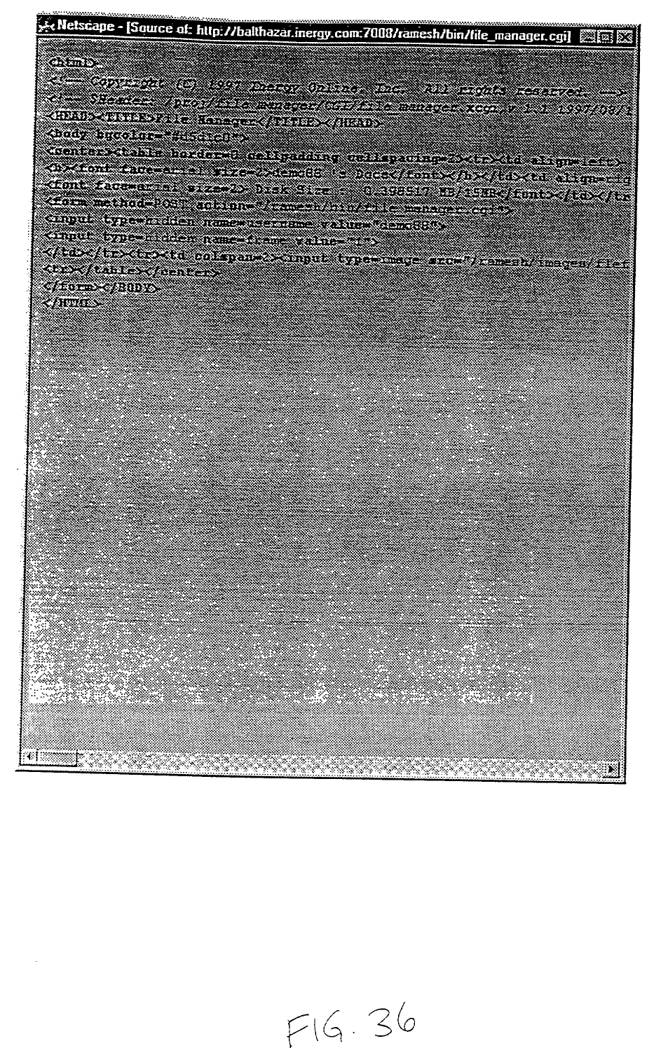

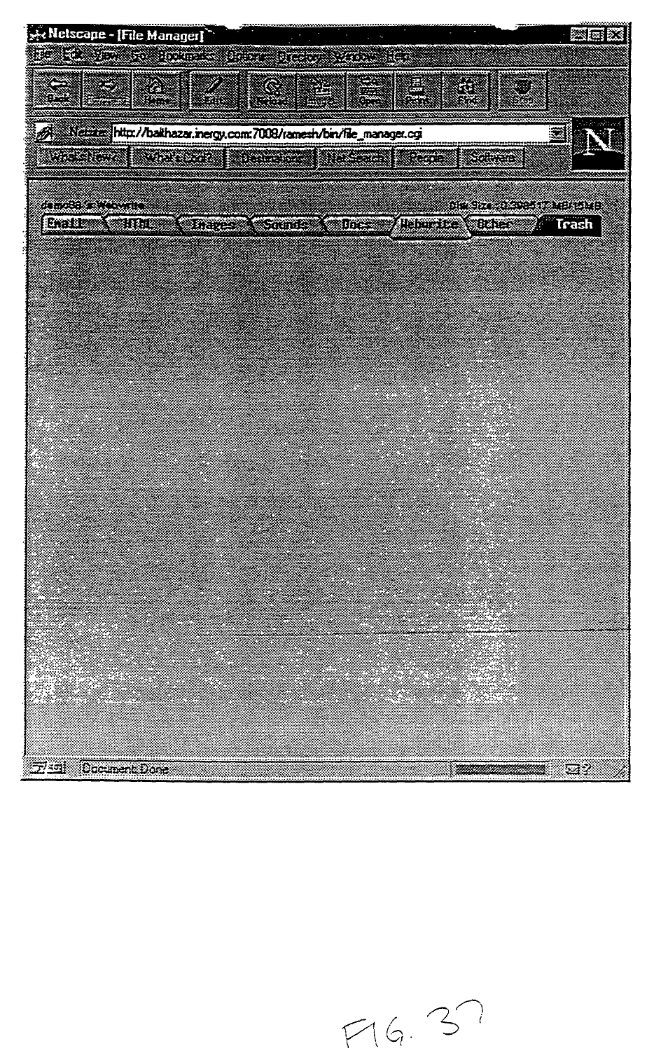

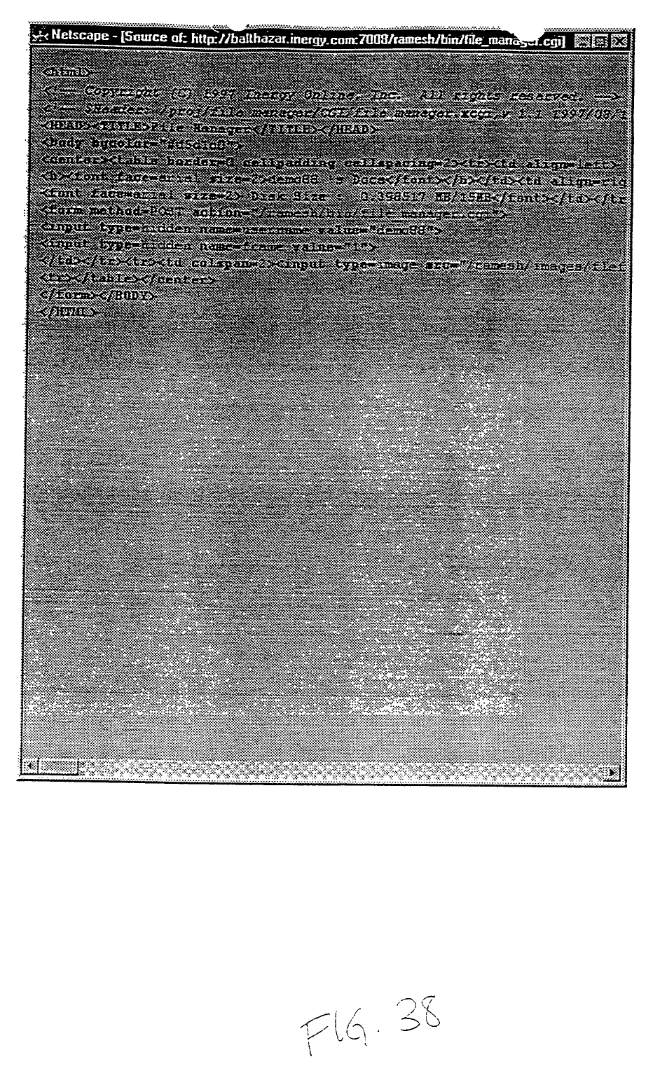

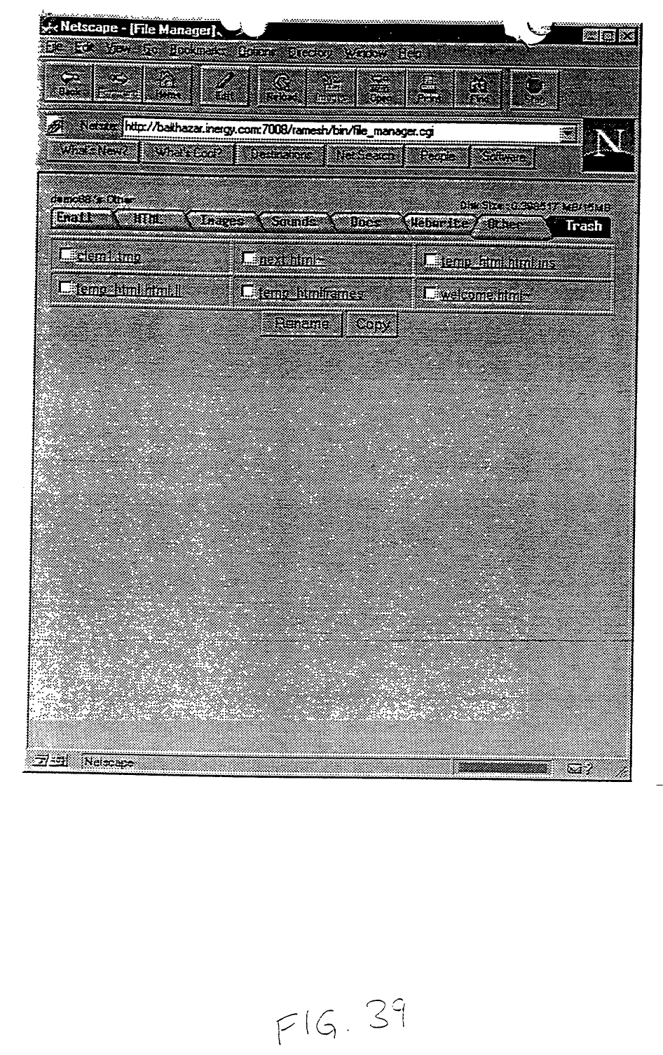

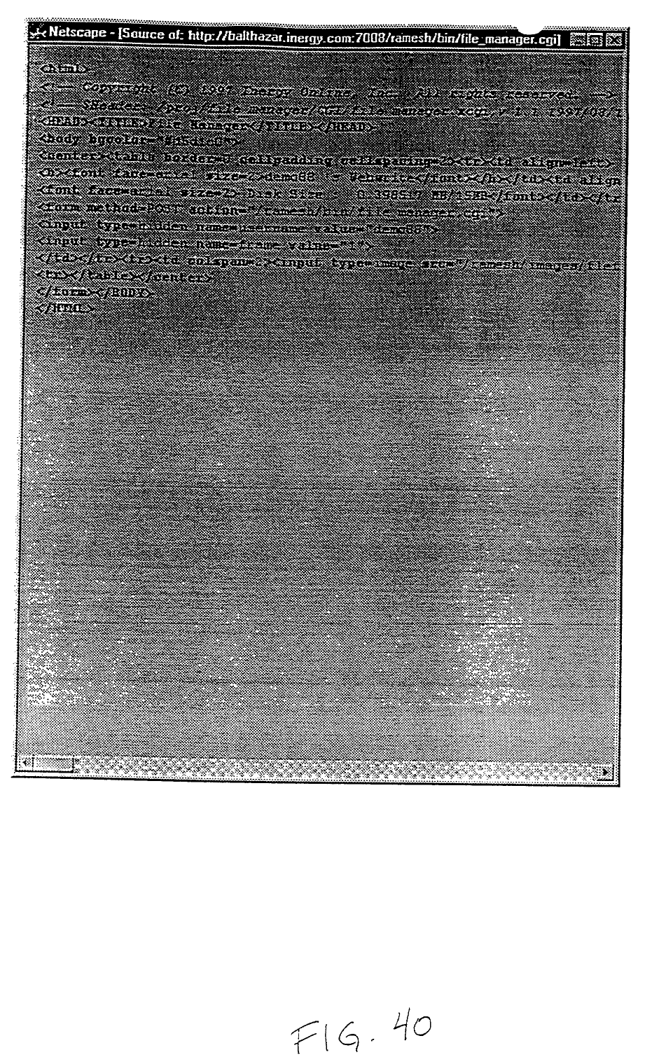

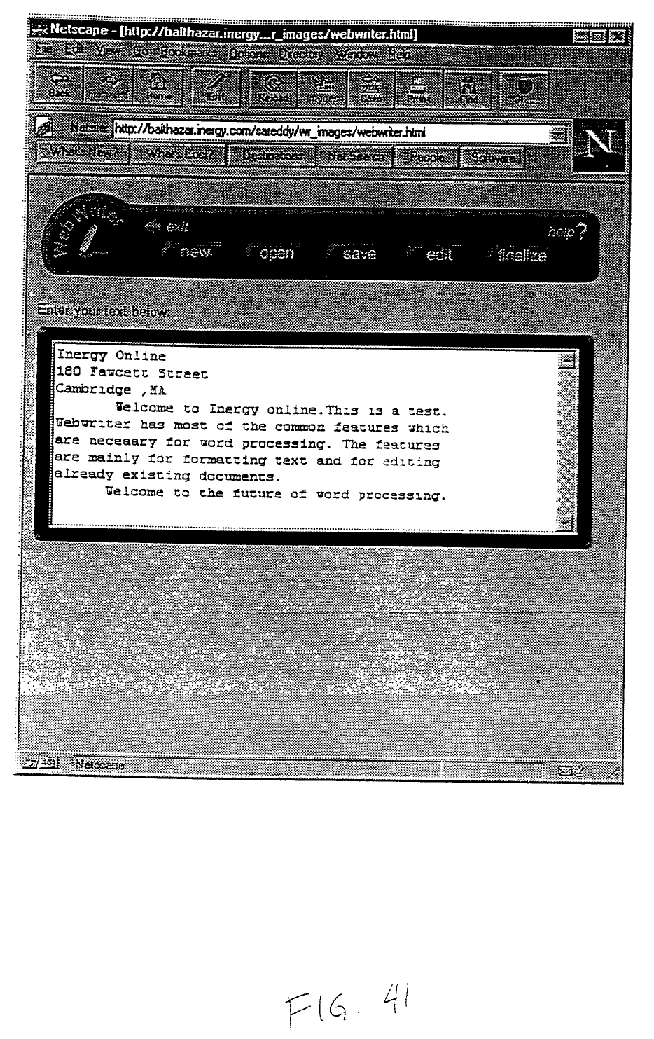

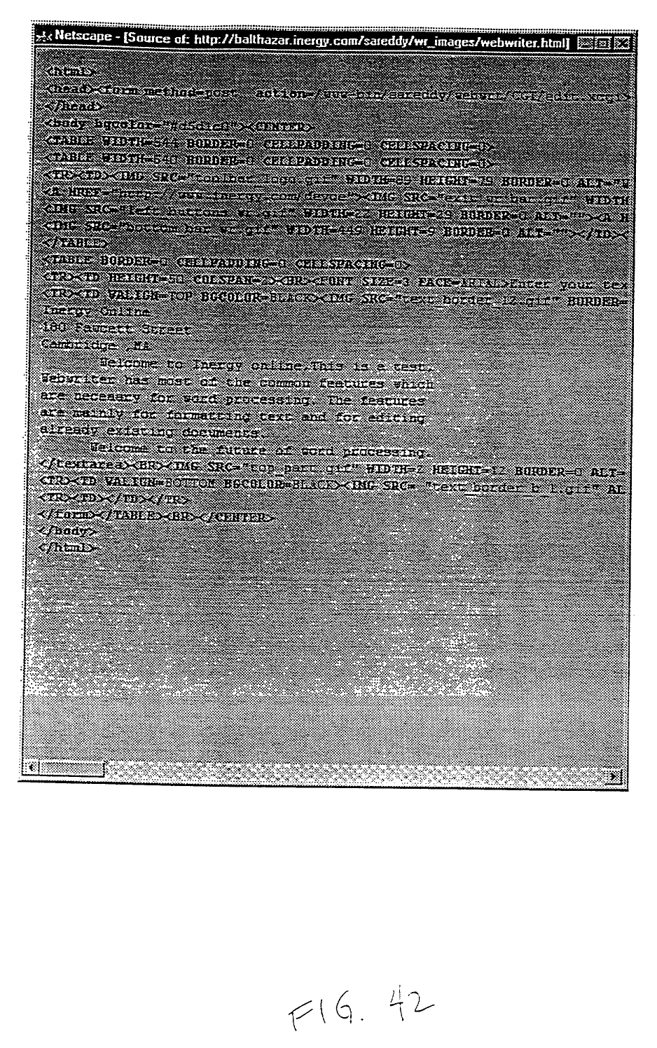

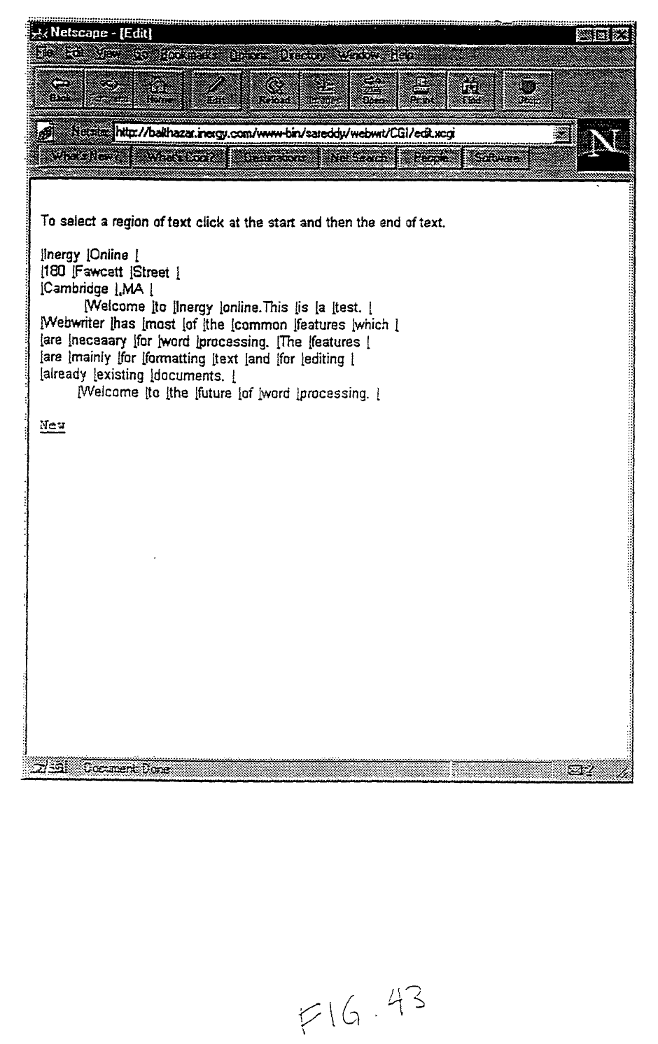

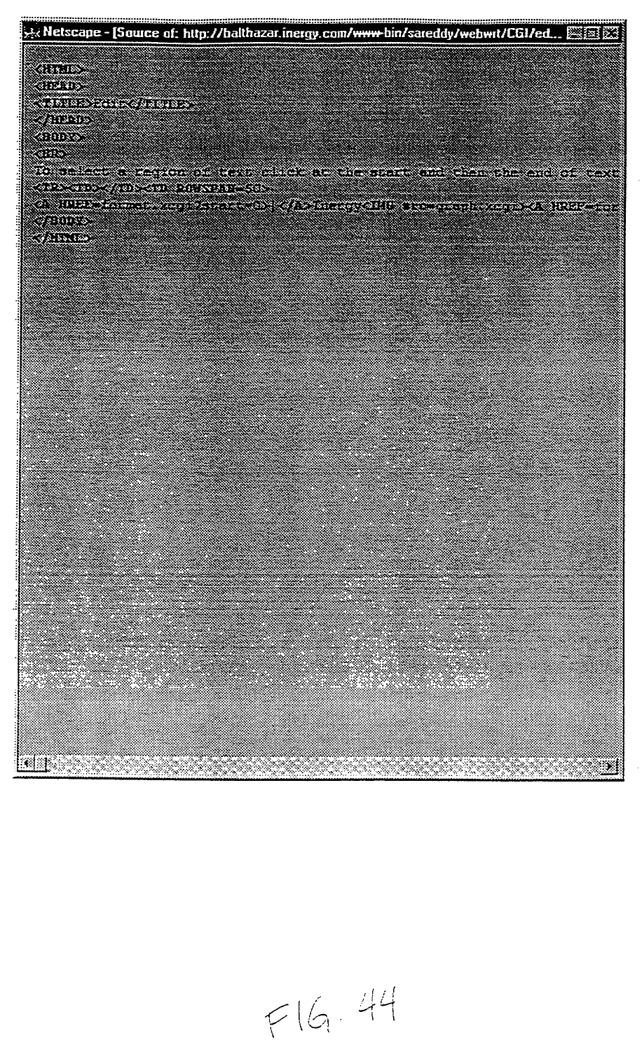

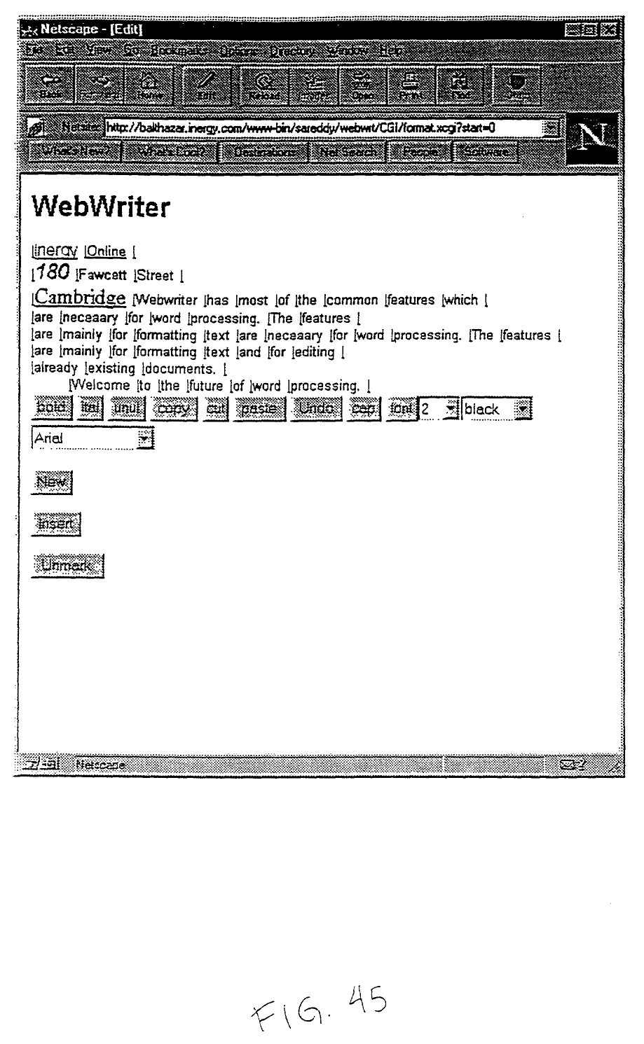

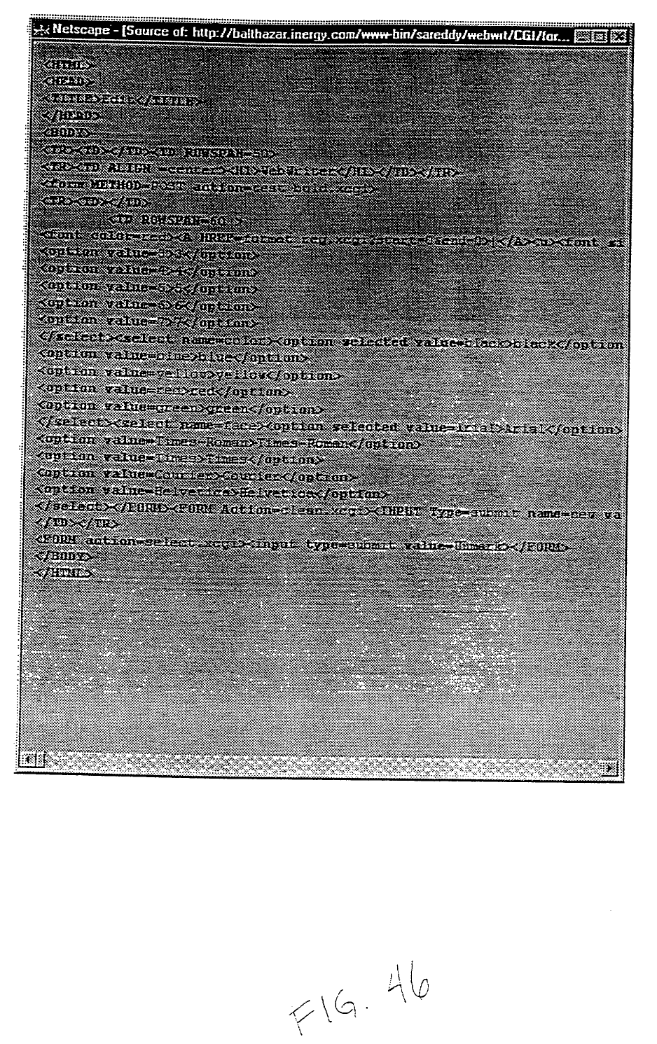

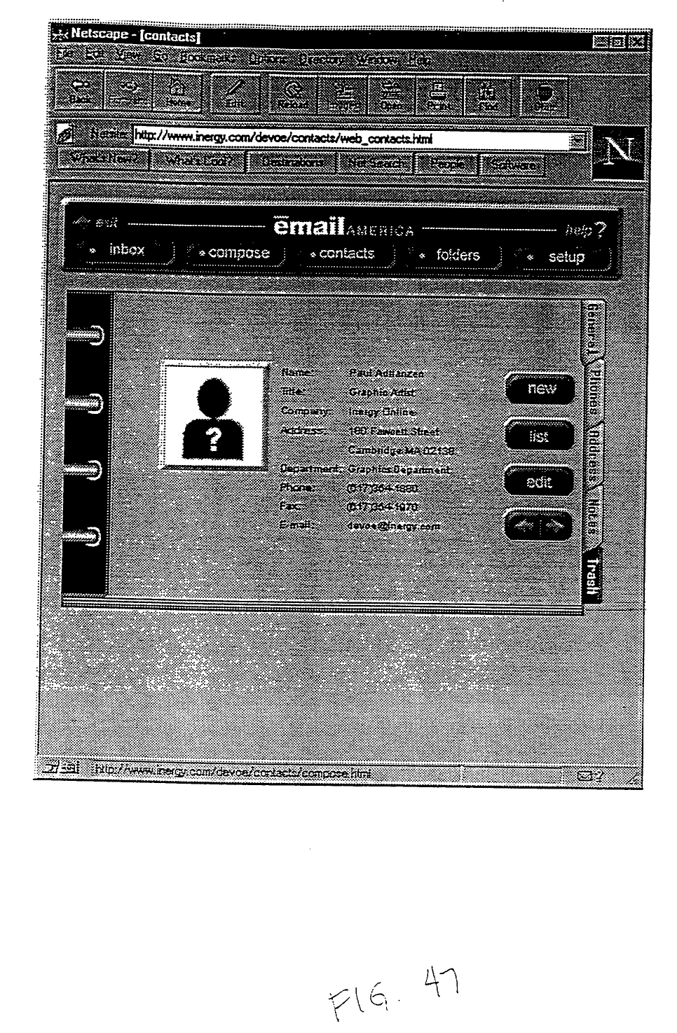

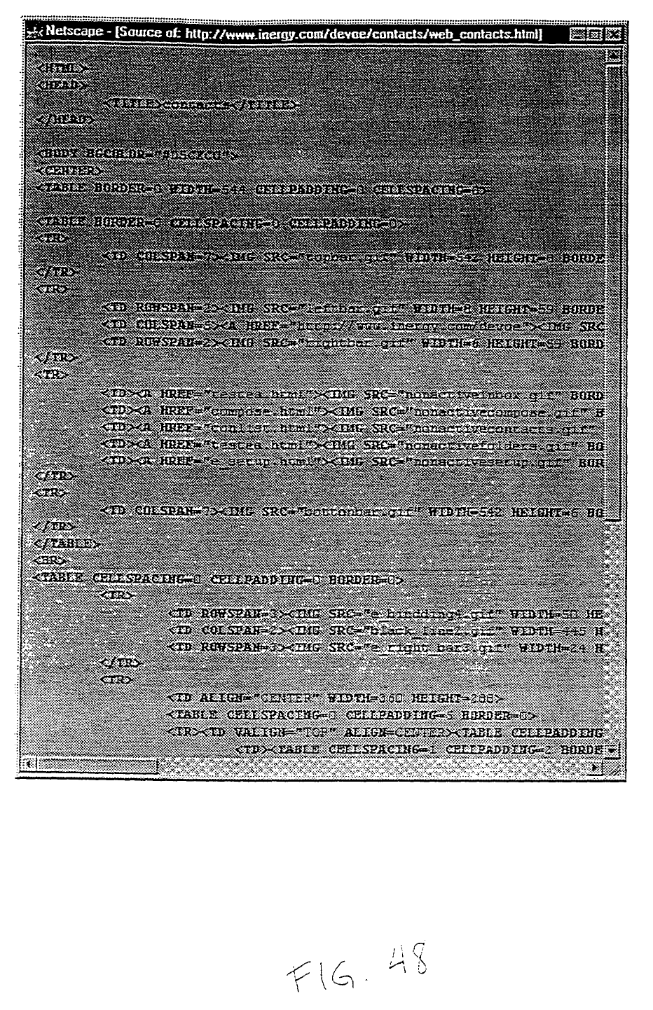

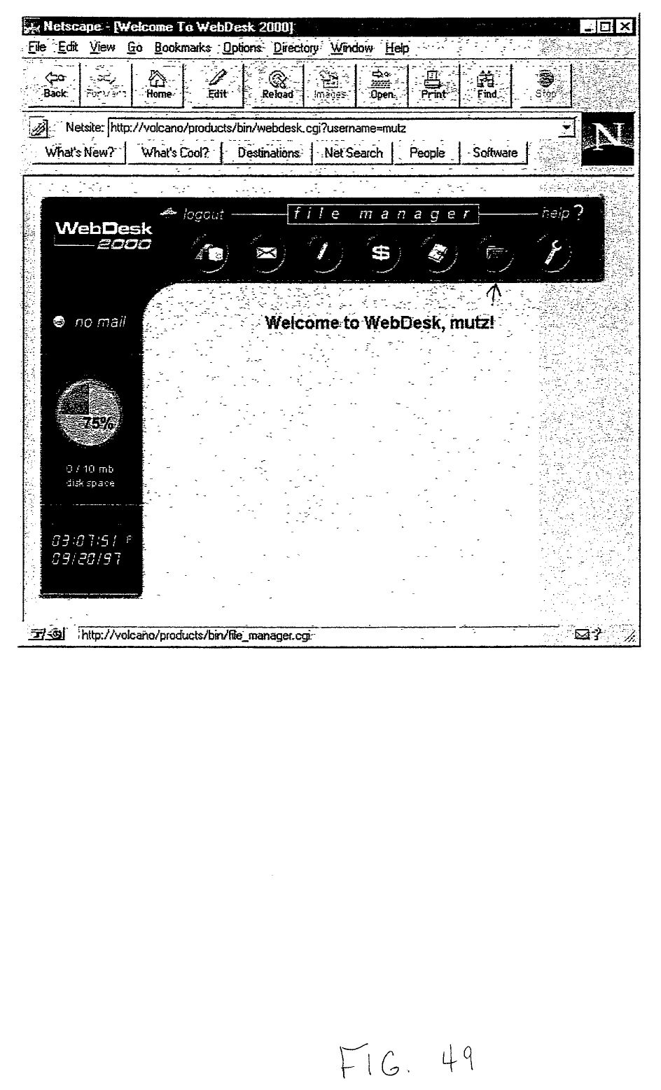

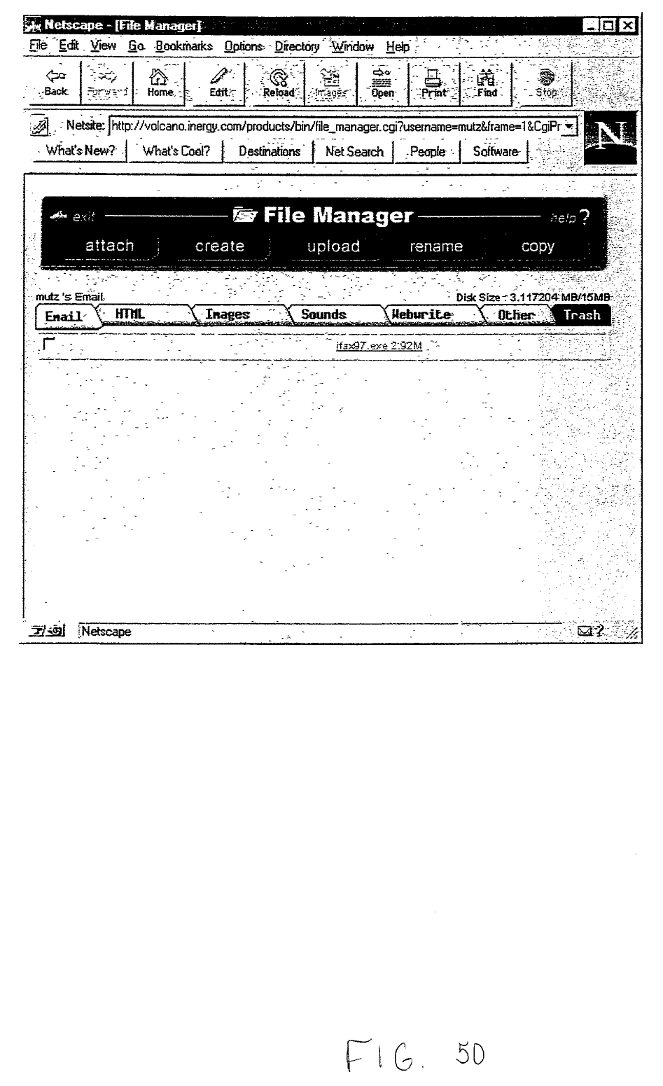

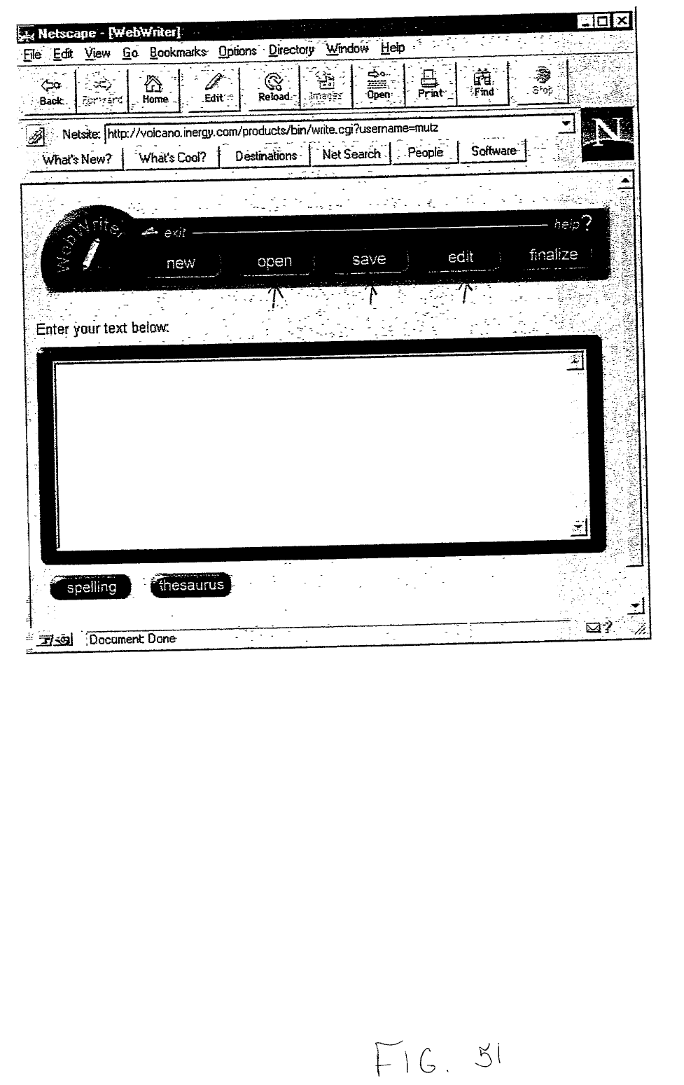

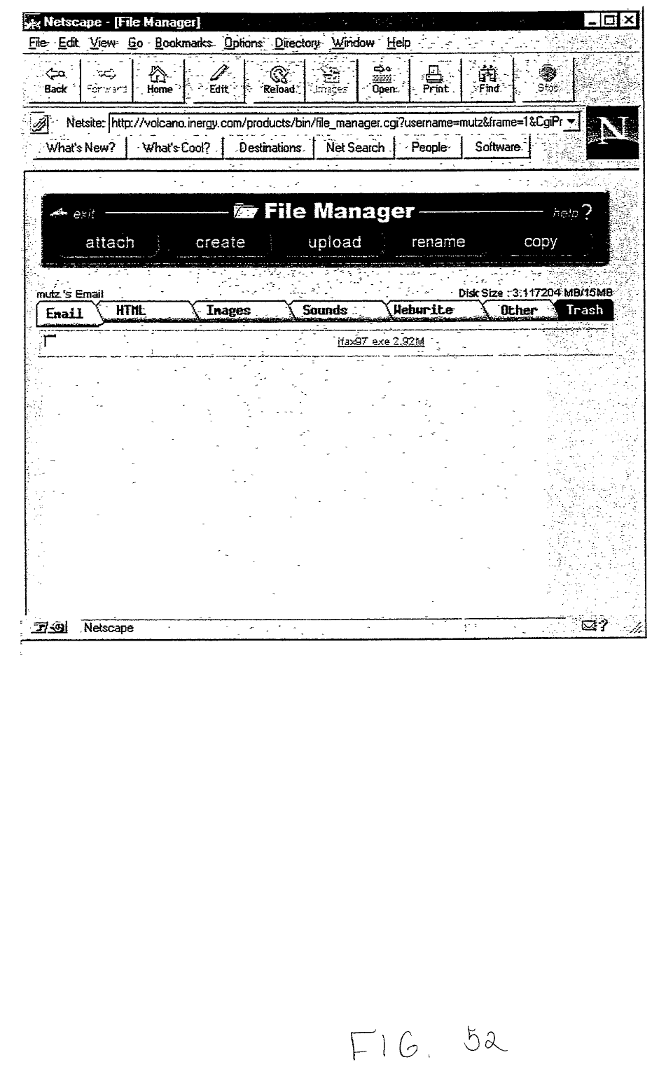

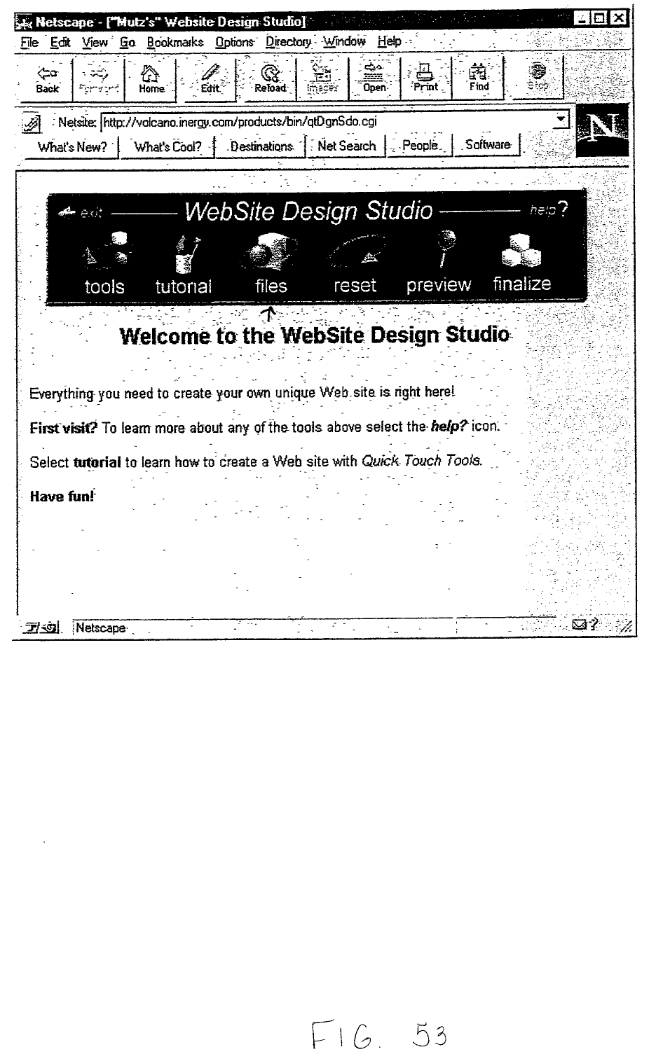

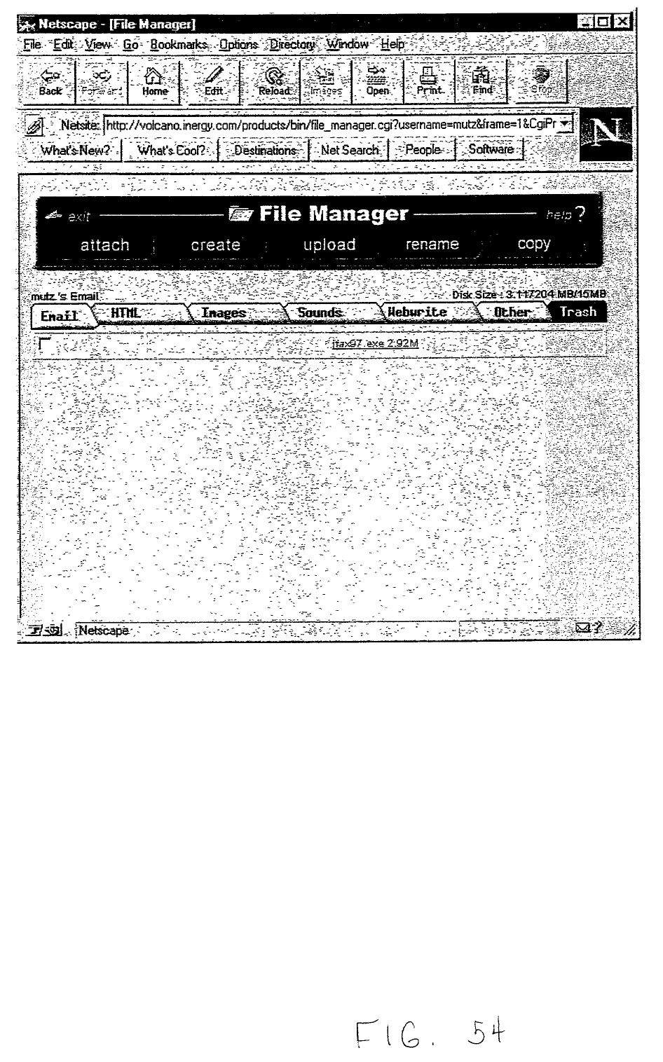

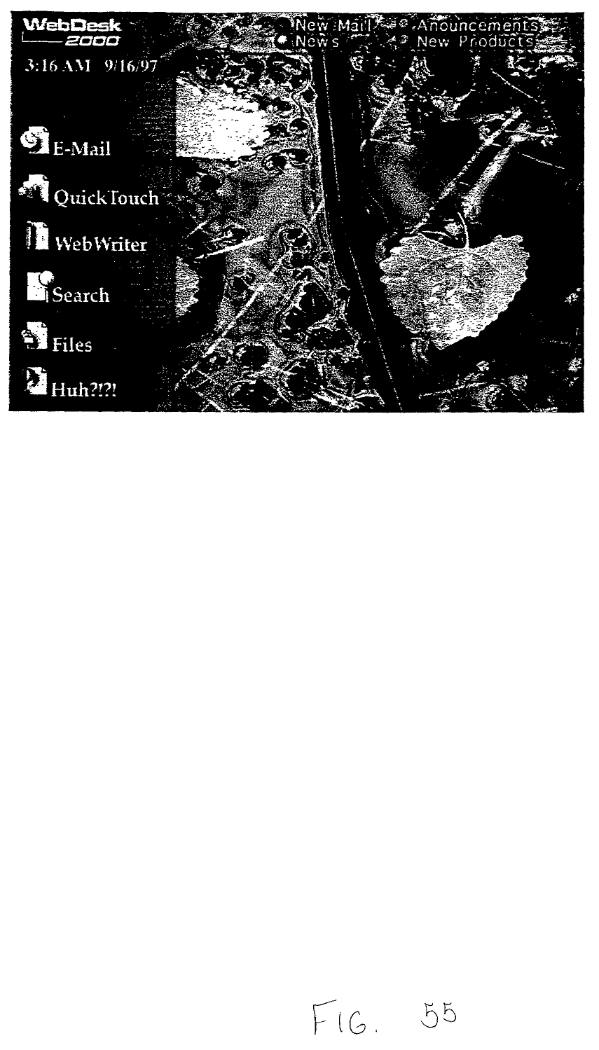

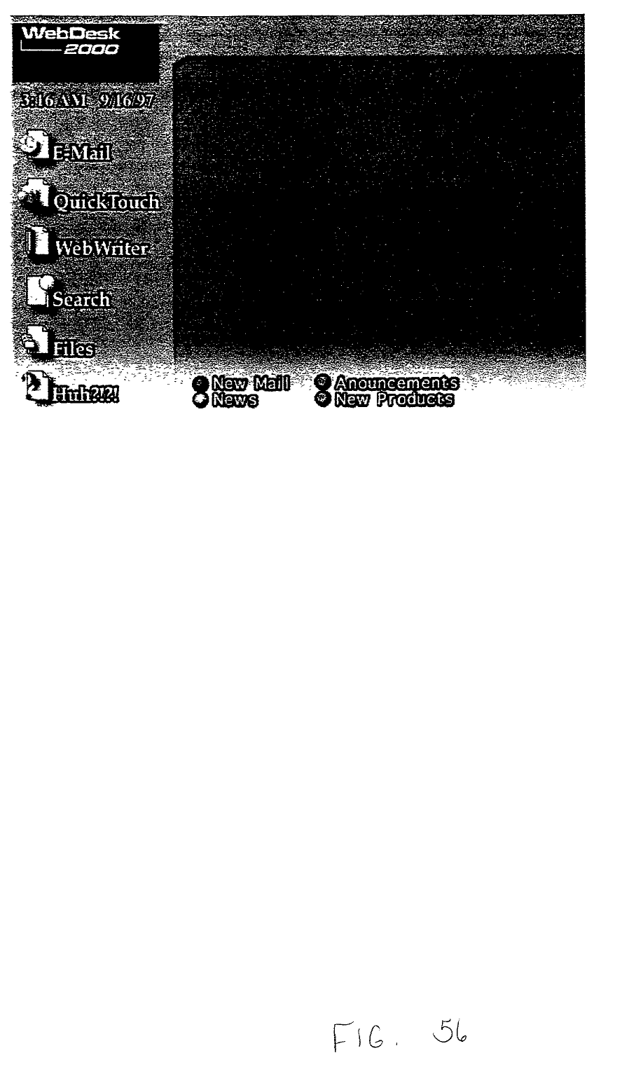

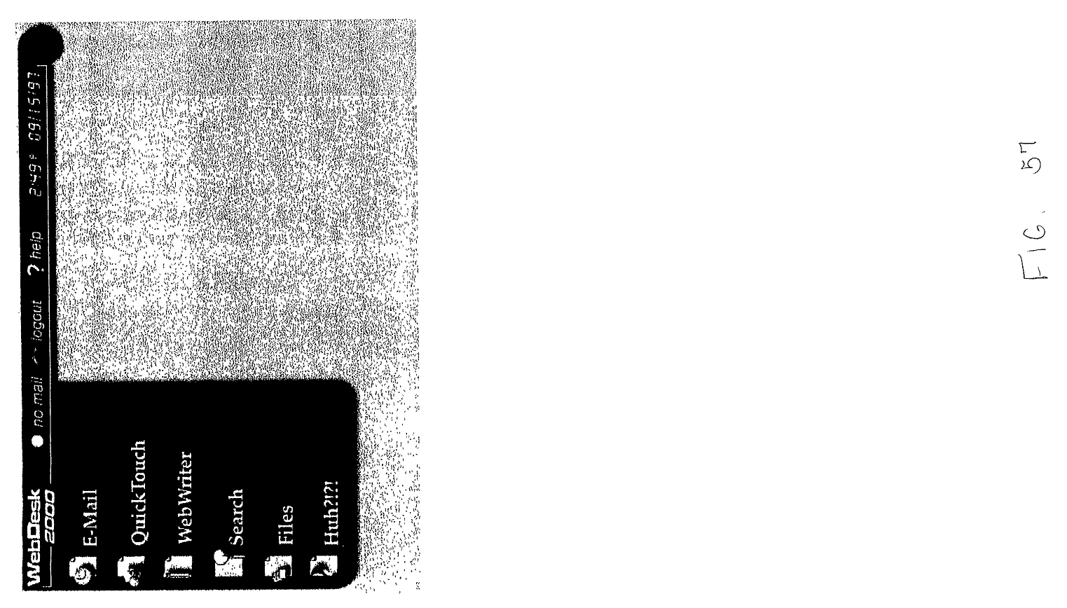

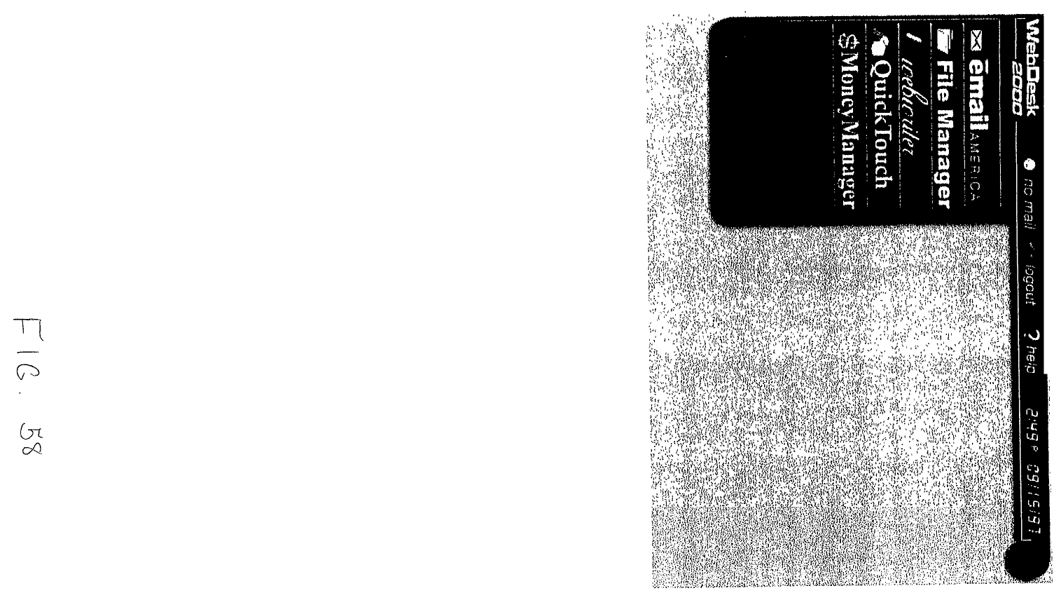

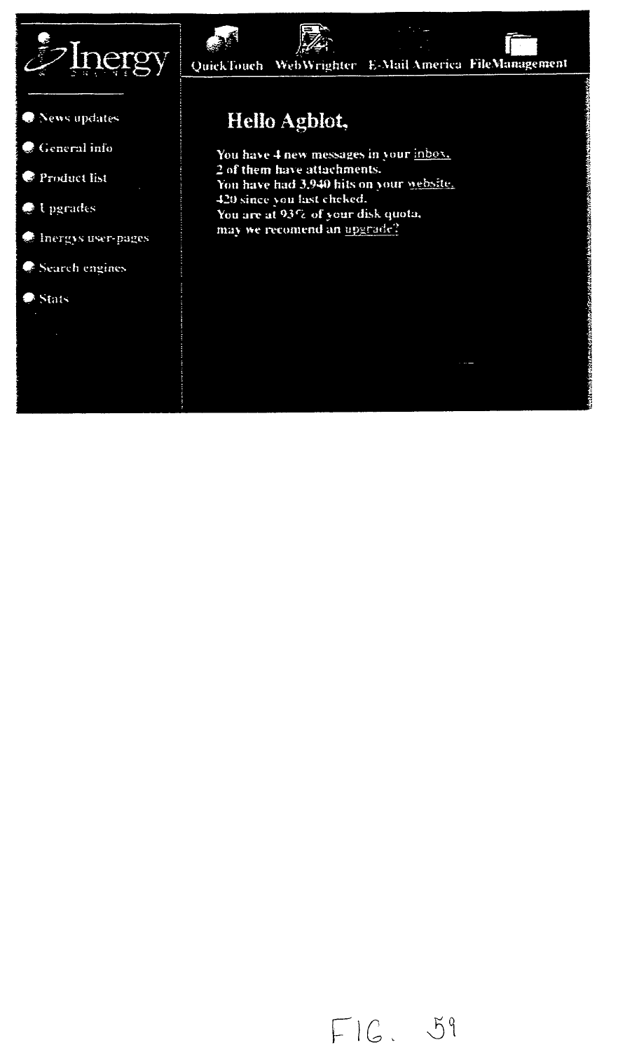

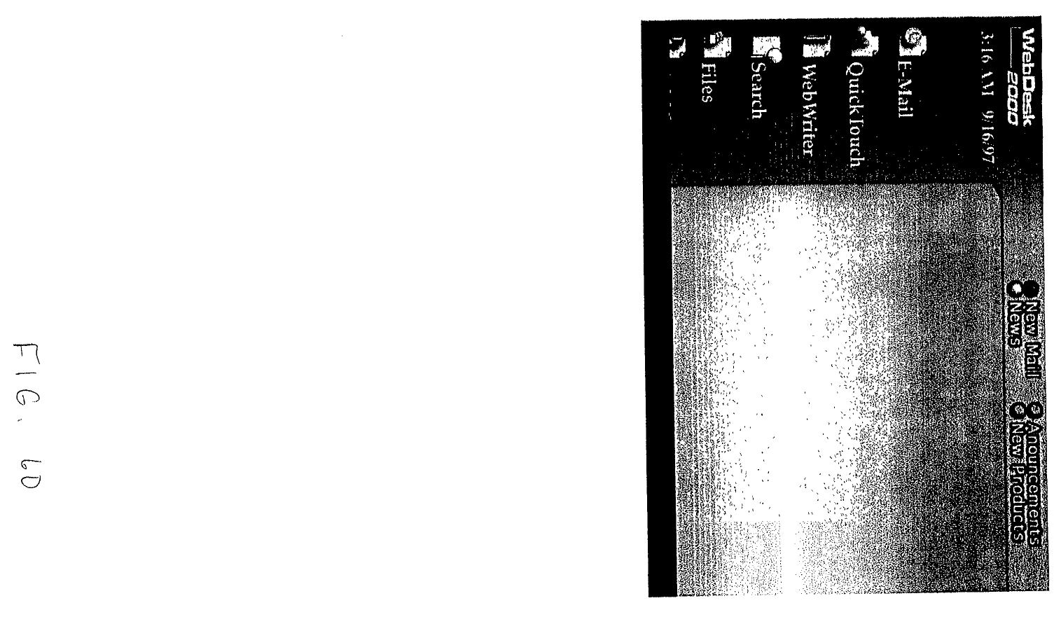

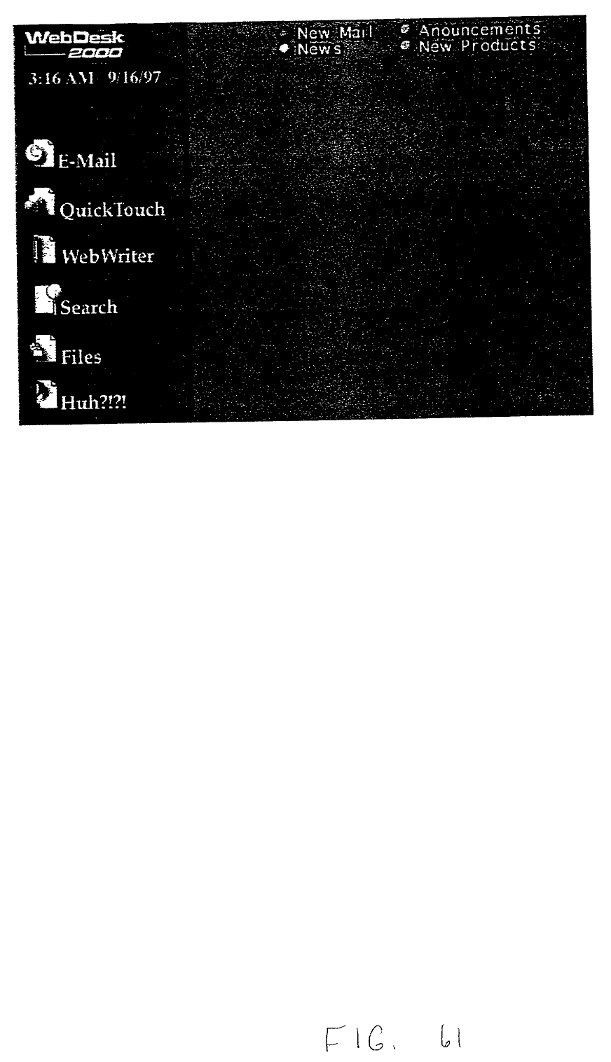

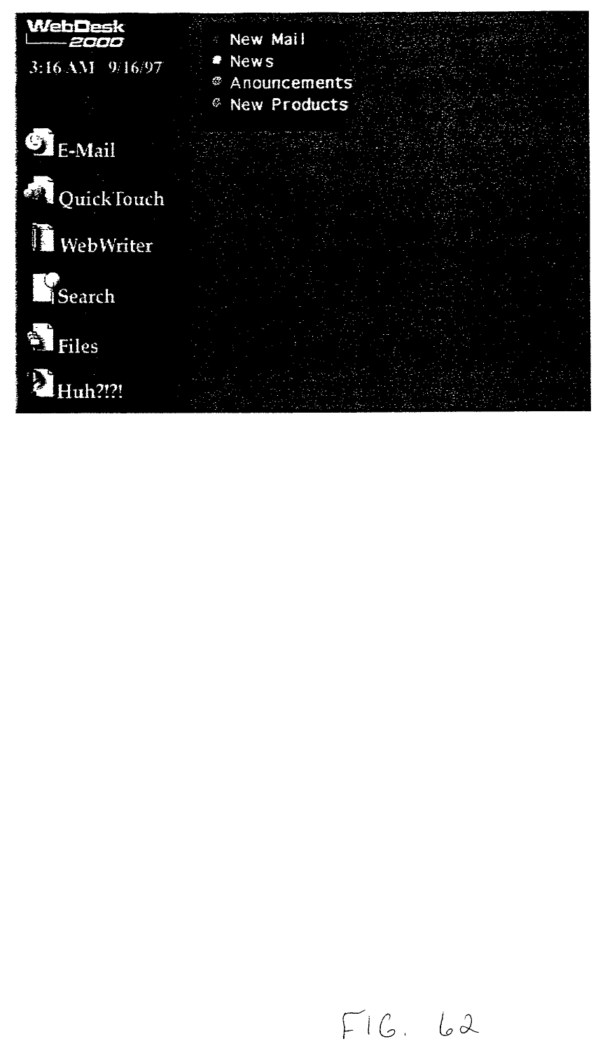

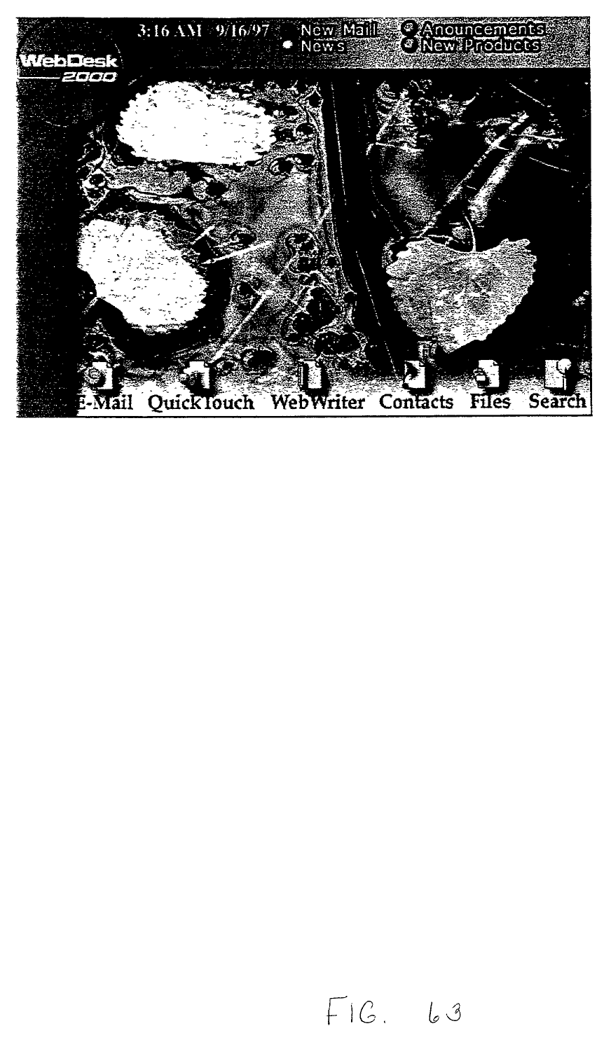

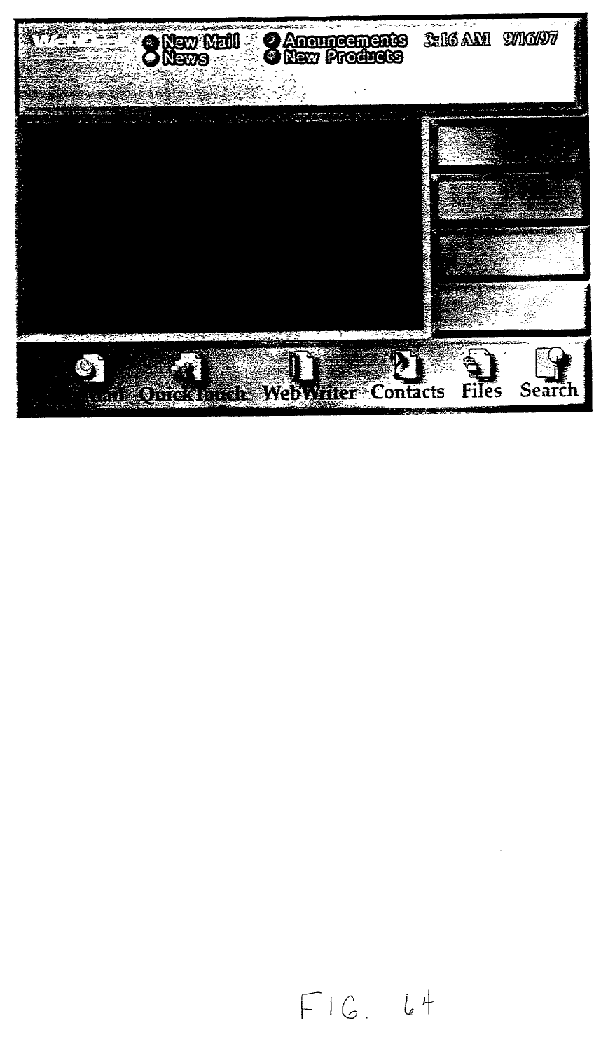

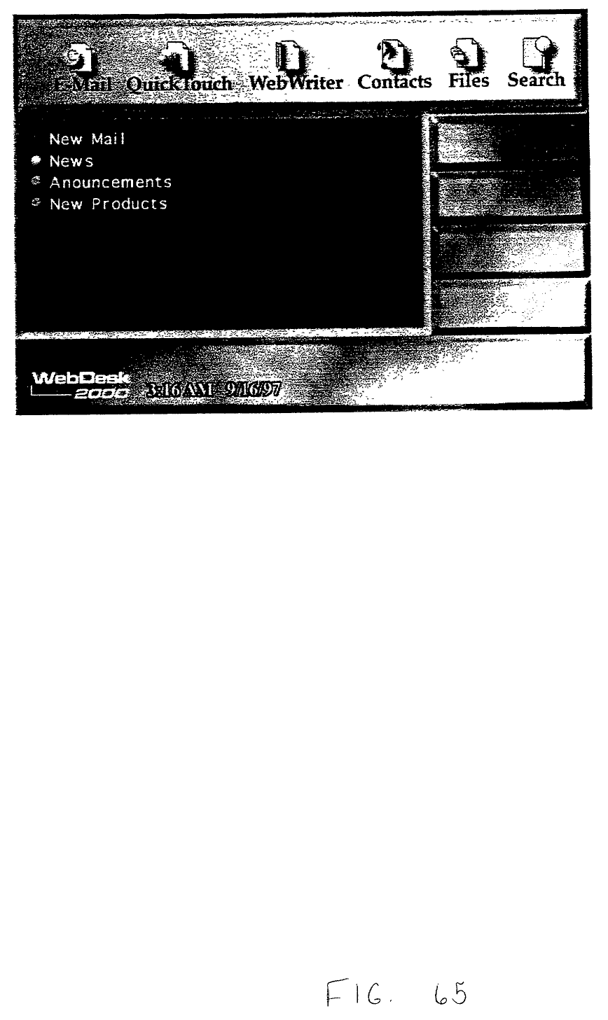

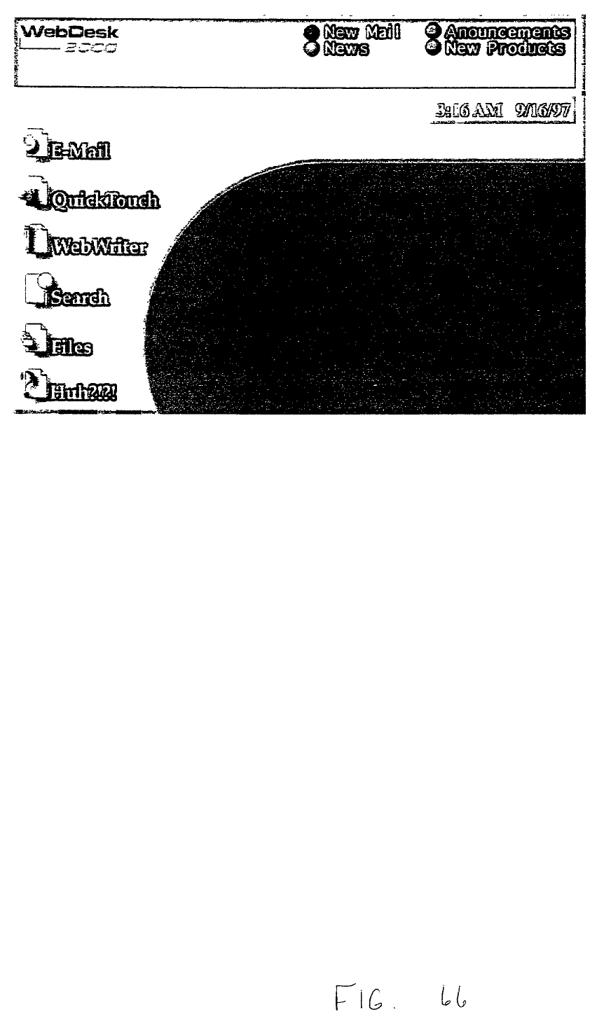

In FIG. 1, a schematic diagram illustrates a method of implementation of a server-sided Internet based operating system according to the present invention. Users, who may have one of a variety of Internet-enabled devices or connections, including, for example, a desktop PC or a laptop, a WEBTV, an Internet pager, or an Internet phone, use their Web browser to enter INERGY's web site, which is http://www.inergy.com. Once on the web site, a new user registers for access to one or more of the applications in the INERGY 2000 operating system's suite of desktop applications, which may include such programs as WEBWRITER (a word processor), E-MAIL AMERICA, WEB SITE DESIGN STUDIO (“QUICKTOUCH”), CONTACT MANAGER (a “PIM” or Personal Information Manager), spreadsheet software, voice-to-text & text-to-voice software, financial management software (including, for example, electronic checkbook and bill payment), personal and corporate bookkeeping, data management, desktop publishing, desktop (or WEBTOP) administration, meeting manager/scheduler, etc., all of which may reside on one or more of INERGY's servers. These applications may be interlaced with online creative multimedia tools. The new user is then given a password, which they may modify, and is given a standard desktop configuration of the applications, including a standard background screen that is displayed when a user logs onto the system. A database, which may reside on the INERGY 2000 server farm or on some other server, is maintained. The database includes a customer profile for each customer. The customer profile, which may include one or more customized desktop configurations, may be updated by the user either consciously, through selection of an option such as “SETUP”, or may be automatically updated as the user rearranges or otherwise modifies their desktop while they are actively connected to the INERGY 2000 operating system. Each user may customize their desktop arrangement. For example, users may upload graphics, text, or sounds to use as a background. Users may add and remove hypertext links to their favorite Web sites. Users may modify the size, shape or arrangement of the icons or symbols that permit access to each of the applications, etc. A user may have one customized desktop configuration for use in the office and another customized desktop configuration for use at home. In addition, a family may have a common desktop configuration (or set of configurations), with different passwords for e-mail for each of the family members, so that each of the family members can have private e-mail.

When a previously-registered user logs in to the INERGY 2000 operating system, the user's login ID and password are sent, using HTTP, to a Web server, which may be located anywhere, and then passed, using CGI code, to the INERGY 2000 operating system, which then accesses the user's customer profile from the database of customer profiles. Based on the data in the user's customer profile, a set of scripts are run, which then are sent back to the Web server, which passes the HTML instructions to the user's browser, using HTTP, and the user's browser then displays the user's customized desktop configuration. The user can then access any of the applications for which they have registered, which may include one or more of the applications shown in the “DESKTOP” layer of the diagram in FIG. 1. Each of the desktop applications also may have access to one or more of the tools in the “TOOLS” layer of the diagram in FIG. 1. For example, a user may receive an e-mail message with an attached document in MICROSOFT WORD format. The user may wish to edit the document using the WEBWRITER program. The FILE MANAGER tool will allow the user to convert the MICROSOFT WORD document into Text format, which the WEBWRITER can read. The user can then edit the document and use FILE MANAGER to convert the revised document back to MICROSOFT WORD format and send it back as an attachment to an e-mail reply message. Or, the user could convert the document for use in the spreadsheet or bookkeeping application. The user also may add the document to their personal or business Web site. A variety of additional options will be apparent. For example, optionally, the spell-check tool may be accessed from the word processing program, as well as from the e-mail program or the Web site creation and management program, etc.

All patents, patent applications, articles, books and other references cited herein are incorporated herein by reference.

While the invention has been disclosed in connection with the preferred embodiments shown and described in detail, various modifications and improvements will be apparent to one of ordinary skill in the art from the above description, including, for example, continuously updating the customer profile, or updating the customer profile at predetermined intervals or points, such as when a user exits the system.

What has been described in detail herein above are methods and apparatus meeting the aforestated objectives. As previously indicated, those skilled in the art will recognize that the foregoing description has been presented for the sake of illustration and description only. It is not intended to be exhaustive or to limit the invention to the precise form disclosed, and obviously many modifications and variations are possible in light of the above teaching.

The embodiments and examples set forth herein were presented in order to best explain the principles of the instant invention and its practical application to thereby enable others skilled in the are to best utilize the instant invention in various embodiments and with various modifications as are suited to the particular use contemplated.

It is, therefore, to be understood that the claims appended hereto are intended to cover all such modifications and variations which fall within the true scope and spirit of the invention.

I claim:

1. A remote communication management system, comprising:
a server computer having memory, wherein the server computer includes a processing mechanism for receiving signals representing a message from a communications network, converting the signals into a data file, and storing the data file in the memory;
a client device adapted for transmitting and receiving signals from the communications network;
a communications connection between the server computer and the client device;
an access control mechanism connected to the server computer for determining access rights to the data file stored in the memory of the server computer; and
a server signal mechanism connected to the server computer and responsive to the access control mechanism for receiving signals from the client device and for sending signals to the client device, via the communications connection, for generating markup language page signals representative of the data file, wherein the processing mechanism, the access control mechanism, and the server signal mechanism permit a user of the client device to view certain of the data files via interaction with the markup language page signals.

2. A system, according to claim 1, wherein the client device is selected from the group consisting of: mainframe computers, desktop personal computers, laptop personal computers, network computers, Internet telephones, pagers, mobile phones, hand-held personal information managers, non-computer (NC) appliances, cable television boxes, television sets, and set-top boxes.

3. A system, according to claim 1, wherein the client device includes a Web browser program.

4. A system, according to claim 1, wherein the communications network is the Internet.

5. A system, according to claim 1, wherein the communications network is the World Wide Web.

6. A system, according to claim 1, wherein the communications network allows communication via wireless transmissions.

7. A system, according to claim 1, wherein the communications network allows communication via transmissions through fiber optic lines.

8. A system, according to claim 1, wherein the communications connection is the Internet.

9. A system, according to claim 1, wherein the communications connection is the World Wide Web.

10. A system, according to claim 1, wherein the communications connection allows communication via wireless transmissions.

11. A system, according to claim 1, wherein the communications connection allows communication via transmissions through fiber optic lines.

12. A system, according to claim 1, further comprising a registration mechanism connected to the server computer for storing, accessing, and modifying a list of names of registered users.

13. A system, according to claim 1, wherein the signals received by the processing mechanism of the server computer represent an electronic mail (e-mail) message.

14. A system, according to claim 13, wherein the e-mail message includes an address field and wherein the processing mechanism determines whether the address field includes the name of a registered user.

15. A system, according to claim 14, wherein the access control mechanism allows only the registered user to whom the e-mail message is addressed to access the e-mail message.

16. A system, according to claim 14, wherein the processing mechanism rejects the e-mail message if the address field does not include the name of a registered user.

17. A system, according to claim 1, further including a mechanism for permitting the user of the client device to delete certain of the data files.

18. A system, according to claim 1, further including a mechanism for permitting the user of the client device to edit certain of the data files.

19. A system, according to claim 1, wherein the server signal mechanism includes a messaging device for generating markup language page signals for composing a message from the client device via interaction with the markup language page signals and for sending the message to the communications network.

20. A remote information management system, comprising:
a server computer having memory, wherein the server computer includes a processing mechanism for receiving signals representing information from a communications network, converting the signals into a data file, and storing the data file in the memory;
a client device adapted for transmitting and receiving signals from the communications network;
a communications connection between the server computer and the client device;
an access control mechanism connected to the server computer for determining access rights to the data file stored in the memory of the server computer; and
a server signal mechanism connected to the server computer and responsive to the access control mechanism for receiving signals from the client device and for sending signals to the client device, via the communications connection, for generating markup language page signals representative of the data file, wherein the processing mechanism, the access control mechanism, and the server signal mechanism permit a user of the client device to view certain of the data files via interaction with the markup language page signals.

21. A system, according to claim 20, wherein the client device is selected from the group consisting of: mainframe computers, desktop personal computers, laptop personal computers, network computers, Internet telephones, pagers, mobile phones, hand-held personal information managers, non-computer (NC) appliances, cable television boxes, television sets, and set-top boxes.

22. A system, according to claim 20, wherein the information includes contact data.

23. A system, according to claim 20, wherein the information includes names, addresses, and phone numbers.

24. A system, according to claim 20, wherein the information includes appointment information.

25. A system, according to claim 20, wherein the information includes reminders.

26. A system, according to claim 20, further comprising a registration mechanism connected to the server computer for storing, accessing, and modifying a list of names of registered users.

27. A system, according to claim 26, wherein the information is sent by a third party and addressed to a registered user.

28. A system, according to claim 26, wherein the information is sent by a registered user and addressed to themselves.

29. A method for remote communication management, comprising:
providing a server computer for receiving signals representing a message from a communications network, converting the signals into a data file, and storing the data file;
providing a client device for transmitting and receiving signals from the communications network;
connecting the server computer and the client device via a communications connection;
receiving signals from the client device;
sending signals from the server computer to the client device for generating markup language page signals representative of the data file; and
determining access rights to the data file, thereby allowing a user of the client device to view the data file via interaction with the markup language page signals if the user is allowed access rights to the data file.

30. A method, according to claim 29, further comprising:
providing a registration process for allowing users to request registration on the system and for storing a list of registered users.

31. A method, according to claim 29, wherein receiving signals representing a message includes receiving signals representing an electronic mail (e-mail) message.

32. A method, according to claim 29, wherein receiving signals representing a message includes receiving signals representing an electronic mail (e-mail) message including an address field.

33. A method, according to claim 30, further including determining whether the address field includes the name of a registered user.

34. A method, according to claim 30, further including allowing the registered user to whom the e-mail message is addressed to access the e-mail message.

35. A method, according to claim 30, further including rejecting the e-mail message if the address field does not include the name of a registered user.

36. A method, according to claim 29, further including allowing the user of the client device to delete certain of the data files.

37. A method, according to claim 29, further including allowing the user of the client device to edit certain of the data files.

38. A method, according to claim 29, further including allowing the user of the client device to compose a message via interaction with the markup language page signals.

39. A method, according to claim 38, further including sending the message composed by the user to the communications network.

40. A remote communication management system, comprising:
a server computer for receiving signals representing a message from a communications network, converting the signals into a data file, and storing the data file;
a client device for transmitting and receiving signals from the communications network;
means for connecting the server computer and the client device via a communications connection;
means for receiving signals from the client device;
means for sending signals from the server computer to the client device for generating markup language page signals representative of the data file;
means for determining access rights to the data file; and
means for allowing a user of the client device to view the data file via interaction with the markup language page signals if the user is allowed access rights to the data file.
